(19) United States
(12) Patent Application Publication
(10) Pub. No.: US 2012/0096389 A1
(43) Pub. Date: Apr. 19, 2012

(54) INTEGRATED WEB-BASED WORKSPACE WITH CURATED TREE-STRUCTURE DATABASE SCHEMA

(76) Inventors: Ran J Flam, Marlboro, NJ (US); Daniel Kogan, Manalapan, NJ (US)

(21) Appl. No.: 13/186,085

(22) Filed: Jul. 19, 2011

Related U.S. Application Data
(60) Provisional application No. 61/394,487, filed on Oct. 19, 2010.

(51) Int. Cl. G06F 3/048

(52) U.S. Cl. 715/777

(57) ABSTRACT

A virtual web-based computing platform combining a particular network database hierarchy, graphical user interface, and integrated suite of computational tools accessible on demand, by which users gain access to an integrated Virtual Workspace for organizing emails, contacts, bookmarks, tasks, documents, notes, and all other relevant information. The network database hierarchy employs unique data structure and methods, allowing the user to centrally store and manage all data, regardless of type, as well as activities (actions taken and documented by the user). Nevertheless, the interface to said database offers a familiar folder/sub-folder “look and feel” using a tree data hierarchy, which gives a common, centralized and unified approach for storing, managing, displaying, and various types of data, regardless of object- and data-types.

### CROSS REFERENCE TO RELATED APPLICATIONS

This application derives priority from U.S. provisional application Ser. Nos. 61/136,624 filed 19 Jul. 2010 and 61/394,487 filed Oct. 19, 2010, both of which are hereby incorporated by reference as if fully set forth herein.

### BACKGROUND OF THE INVENTION

1. Field of the Invention

The present invention relates to network software systems and, more particularly, to a virtual web-based computing workspace which provides users with an integrated combination of tree-structure network database hierarchy, user interface, and integrated suite of computational tools accessible on demand by which said users can organize their Email, Contacts, Tasks, Documents, Notes, Bookmarks, Online Shopping, Accounts, Phone Calls & Meetings, Music, and any other relevant pieces of information more efficiently, within said network database.

2. Description of the Background

Most people save their documents, contacts, and emails on one or more computers and/or cell phones. They keep their most-visited websites bookmarked in their favorite browser. They also use individual software applications including task management applications, email applications, file managers, etc., all with their own unique user interface. Some applications are desktop applications and web-hosted applications. Consequently, some of the resulting information is stored locally and some is stored and managed on the internet using sites such as Yahoo, Facebook, Linkedln and Google, with the widest common denominator being email and contact information. Web users also “book mark” favorite sites, so that they can use these repeatedly when needed. It becomes very cumbersome to deal with data spread across such a variety computing devices and applications, locally and remotely, especially when it comes to remembering “what is stored where”, “what to do when”, and physically search and locate papers and documents. It is also cumbersome to learn a variety of applications for handling the data and related activities, including manual methods; laptop/desktop based software, as well as various Internet sites web applications. Consequently, users waste considerable time in managing their “daily agenda”, managing the vast amounts of data and related activities related to their agenda, and experience considerable “human errors”, “missing in action”, time lost, and ultimate frustration.

There have been efforts to provide a more integrated working environment. For example, Microsoft Office® is a proprietary commercial office suite of inter-related desktop applications, servers and services for the Microsoft Windows and Mac OS X operating systems, introduced by Microsoft in 1989. Current versions of Office® contain various applications including Microsoft Word™, Microsoft Excel™, Microsoft PowerPoint™ and Microsoft Outlook™, among others. While such desktop information management suites are useful they are still a collection of different programs each geared toward a different type of data structure. A user will generate anything from office documents to forms to website content, corporate records, emails, drawings, contact information, scanned images and documents, etc. The desktop office suites are not very good at overarching management of all such data of all types.

Workspace virtualization is a more robust way of distributing applications to client computers by bundling several applications together into one complete workspace. A virtual workspace encapsulates all information objects and tools in a single computing workspace, integrating everything above the operating system kernel—applications, data, settings, and anything else required to provide a functional desktop computing environment. Past efforts to develop a virtual workspace include United States Patent Application 20060036476 by Klem published Feb. 16, 2006 discloses a system and method for tracking information in a business environment. The system uses a tree-view hierarchy whereby alerts and time triggers are set by the user and upon the triggering of an event, the visual attributes of the tree-view folders change to reflect the triggering event. The user still needs to activate five main program sections for monitoring and managing a business enterprise.

U.S. Pat. No. 5,794,001 to Malone et al (MIT) discloses an “object-oriented computer user interface” in which user-definable objects of multiple types are graphically represented and displayed. A user defines his or her own data entries using a template. All data is encapsulated within defined objects and this insulates the user from the details of how that data is accessed. Objects are linked as defined members of a class. Classes are organized into an entangled hierarchy. Thus, each class has a super-class or parent from which it inherits certain characteristics and methods which instance-objects of the class use for retrieving, changing, or presenting the data in the object.

U.S. Pat. No. 6,891,552 to Bush (Microsoft) issued May 10, 2005 shows a system and method of displaying data representing an object of a class where the class has one or more attributes and each object has an attribute value associated with each attribute. The invention allows a software application to access the objects in a database. The invention provides a user interface (UI) attribute within the class that allows the user to specify the UI to display the attribute values of each accessed object. Each available UI is customized to a statistic to be monitored.

U.S. Pat. No. 7,188,308 to Weise et al. issued Mar. 6, 2007 discloses an interface for permitting a user to explore a collection of data. The data collection provides nodes as structural elements, and references which are assigned to nodes and hold the address of another node. Multiple references can be assigned to each node, thus guiding a user of the system to multiple other nodes, and multiple references can hold the same address, so that multiple nodes can have references pointing to the same node. The interface allows visualizing a network with interconnected nodes on a display region.

U.S. Pat. No. 7,729,924 discloses a “Virtual knowledge management system” which controls the flow of information in a virtual knowledge base 20 on the basis of user-defined information flow control data 40 input through process forms.

The foregoing references do not fully provide any interface for allowing a user to manage and search a complex array of data, and to navigate within the array. As a result, bandwidth utilization is large and end user experience suffers. It would be more advantageous to provide a virtual web-based computing workspace with an integrated combination of network database hierarchy, user interface, and integrated tools all accessible on demand which allow users to organize emails, contacts, bookmarks, tasks, documents, notes, and all other relevant information within said network database.

In computer science, a data structure is a particular way of storing and organizing data in a computer so that it can be used efficiently. Common data structures include arrays, linked lists, hash-tables, heaps; tree structures, tries, stacks, and queues. Unstructured data does not have a pre-defined structure and may include documents, metadata, records, audio, video, files, and unstructured text such as the body of an e-mail message, Web page, or word processor document. Different computing devices and different applications use unstructured data along with different kinds of data structures each highly specialized and best suited to specific tasks. The result is a mish mash of structured and unstructured data stored in myriad different locations on different devices. Faced with growing knowledge management needs, individuals and enterprises are realizing the importance of seamlessly integrating critical business information derived from multiple diverse structured and unstructured data sources. However, in a typical enterprise environment the structured data is managed by a database system and is accessed by a query interface such as Structured Query Language (SQL), while the unstructured data is managed by the various applications, creating an artificial separation between the two. This separation is unfortunate since the information contents of these two data sources are often related and/or complementary. Interlinking the unstructured documents with related structured data enables consolidated analysis of information spread across the two sources. There are existing techniques for structuring unstructured data, such as by tagging objects with metadata. In and of itself, this only consolidates the data but does not simplify or speed access to it. There are also existing techniques for consolidating data from multiple devices. Cloud computing is growing in popularity because it relies on a shared pool of configurable computing resources (e.g., networks, servers, storage, applications, and services) and does not require user knowledge of the physical location of data or configuration of the system.

What is needed is a cloud-based system for high performance integration, processing and searching of structured and unstructured data in an optimized structure.

A tree is a widely-used hierarchical data tree structure with a set of linked nodes. Each node has zero or more children nodes and at most one parent node. A node may contain a value, a condition, or represent a separate data structure which could be a tree of its own. Each node in a tree has zero or more child nodes, which are below it in the tree. A node that has a child is called the child's parent node (or ancestor node, or superior). A node has at most one parent. Nodes that do not have any children are called leaf nodes or terminal nodes. The topmost node in a tree is called the root node. A tree data structure is a powerful tool for organizing data objects. Data stored in a tree can be displayed as a “tree-view” of folders and sub-folders.

The present invention provides a cloud-based system for high performance integration, processing and searching of structured and unstructured data in a tree structure of folders with user-friendly column headings and data forms, allowing central data management of structured and unstructured data, linkage ability among entries in said structures, instant search and location of anything, full customization, and a platform for selectively combining user data into a “curated database”, curated by experts who provide authority Wikipedia-style.

### SUMMARY OF THE INVENTION

It is, therefore, an object of the invention to provide a comprehensive cloud-based virtual workspace, database structure and tools for organizing and managing diverse information objects including email, documents and to-do items in a fully integrated fashion, thereby streamlining data management, data flow and user actions.

It is a more specific object to overcome the disadvantages of prior art software solutions in managing the typical “daily agenda” of individuals, households and small businesses.

It is still another object to provide a virtual workspace as described above that is platform independent: accessible using commercially available browsers, such as Internet Explorer by MS, Firefox by Mozilla, Safari by Apple and Chrome by Google.

It is still another object to provide a virtual workspace as described above that serves as a common place for centralized access and handling of email, to-do items, bookmarking favorite web sites, contacts, on-line shopping, accounts, real estate properties, notes, documents, pictures, manuals, inventories, etc.

In accordance with the foregoing objects, the present invention provides a virtual web-based computing workspace comprising a network database hierarchy and an integrated suite of computational tools accessible on demand by which said users can organize diverse forms of data entries including emails, contacts, bookmarks, tasks, documents, notes, and all other relevant information, with the ability to link relevant entries, all from a centralized virtual desktop relying on a network database.

The network database employs unique data structure and methods, allowing the user to store and manage all data, regardless of type, as well as activities (actions taken and documented by the user) using a web-based workspace. The tree data structures and interface methods include predefined and user-defined folders having a familiar “look and feel”, providing the user with consistent methods for handling same regardless of whether the content is data, activities, or both. Specifically, data and objects are arranged into various folders and sub-folders using the tree data hierarchy, giving a common, centralized and unified approach for storing, managing, displaying, and various types of data, regardless of object- and data-types. Each folder or sub-folder may contain objects and/or data, such as email, notes, favorite sites, contacts, to-do-items (TDIs), documents, scanned documents, and pictures (jpeg, gif, etc.). The user has the ability to create new entries (records) in the Workspace, regardless of the specific object or data type, using unified tools and methods.

The virtual internet-based workspace facilitates the storage and handling of all the user's data and activities, with reliable on-line backup (as well as site redundancy).

In accordance with the method of the invention, a user registration mechanism is provided by which each newly-registered user is assigned a dedicated Workspace with folders and sub-folders, all pre-configured based on user feedback provided through said registration process. If desired, users may create a plurality of Workspaces for themselves, each assigned to that user.

Importantly, the invention additionally provides a data sharing feature and related curated database feature. In the former, each user has the ability to grant access to a user's Workspace to another user (“Guest User”) using a mechanism by which the Guest user requests access and the owner of the given Workspace (“Workspace Owner”) accepts or rejects said request. The Workspace Owner may also specify access permissions for specific Guest Users on a folder or sub-folder basis, including modify, delete, create new entries, and may limit operations a Guest User may perform on same. The system also allows sharing of selected folders, sub-folders, as well as selected entries therein with other users on an ad hoc basis. The system also allows users to offer expert data content via their own Workspace through the system to the overall user population. The system also provides a curation platform by which other users become aware of expert data offered by the various experts, so that they can elect to view said expert data.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a block diagram of the exemplary network architecture suitable for implementing the present invention.

FIG. 2 is a screen capture of an exemplary user virtual Workspace according to the invention.

FIG. 3 is a screen capture of an exemplary user-populated virtual Workspace according to the invention.

FIG. 4 is a screen capture of the same user's Workspace of FIG. 3 with a different sub-folder of the “My Documents” top-folder selected.

FIG. 5 is a screen capture of the user's Workspace of FIG. 4 after clicking on the “Alana Johnson” contact entry.

FIG. 6 is an example of Multi-value Reference DF using an Object Label: Association.

FIG. 7 is a screen capture of an example DEF opened in the DEF Form Editor.

FIG. 8 is a screen capture of an FT definition form for My Contacts folder.

FIG. 9 illustrates the DEF form used to configure Related Folders using two Multi-value Reference DFs.

FIG. 10 is a screen capture of an example of the “My Contacts” top-folder.

FIG. 11 is a screen capture of the “My Contact Groups” sub-folder using the tabular-view 20.

FIG. 12 is a screen capture of the “My TDIs” top-folder shown in the tabular-view.

FIG. 13 is a screen capture of an exemplary TDI.

FIG. 14 is a screen capture of the Action Taken form.

FIG. 15 illustrates how the View Related Entries feature is accessed from the right-click menu.

FIG. 16 is a screen capture of the Browser Tree View (BTV) which is an extremely effective tool for menu selection.

FIG. 17 is a screen capture of the right-click menu.

FIG. 18 is a screen capture illustrating both the Tabular-View Tool-Bar Buttons above the tabs, plus the Tabular View Right-Click Menu (TVRM).

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

Hereinafter, a virtual web-based computing system is described in which users are provided with an integrated Virtual Workspace built atop a particular network database hierarchy, graphical user interface, and integrated suite of computational tools accessible on demand, by which said users can organize their emails, contacts, bookmarks, tasks, documents, notes, and all other relevant information within said network database.

Hardware Architecture

The present invention is implemented in an application service provider (ASP) network to facilitate user-registration and subscription and maintenance of the individual workspace.

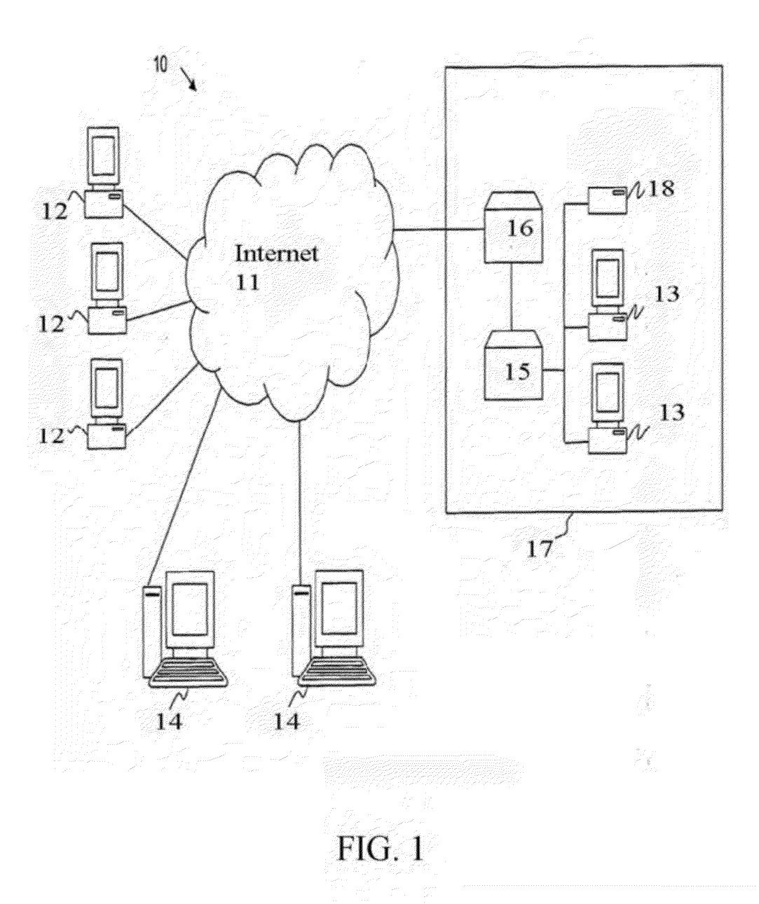

As shown in FIG. 1, ASP network 10 may include a plurality of clients 12 and servers 14 connected via the internet 11. Any number of clients 12 and servers 14 may participate in such a network 10. The system further includes at least one ASP local area network 17 (“LAN”) for hosting and allowing administration of the system by administrators using ASP clients. The internet or World Wide Web provides a known system for interconnecting clients 12, servers 14 and ASP LAN 17 in a communicating relationship. However, other networks may be used, such as satellite networks, the Public Switched Telephone Network, Wife networks, WiMax networks, cellular networks, and any other public, private, or dedicated networks that might be used to interconnect devices for transfer of data.

An exemplary client 12 may include a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, digital subscriber line (“DSL”) card, cable modem, network interface card, wireless network card, or other interface device capable of wired, fiber optic, or wireless data communications. One example of such a client 12 is a personal computer equipped with an operating system such as Microsoft Windows, UNIX, or Linux, along with software support for Internet communication protocols. The client 12 includes at least one browser program, such as Microsoft Internet Explorer, Google Chrome™, Netscape Navigator™, Firefox™ or the like to provide a user interface for access to the general internet 10. Personal users will typically access the system via a client 12, and a typical client 12 may be a conventional web-enabled personal computer, mobile computer, Web phone, VOIP device, television set-top box, interactive kiosk, personal digital assistant, wireless electronic mail device, or other device capable of communicating over the Internet.

Corporate users will typically access the system via a server 14, and an exemplary server 14 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic and may include separate servers for different functions. Such servers may further include one or more mass storage devices such as a disk farm or a redundant array of independent disk (“RAID”) system for additional storage and data integrity. Suitable servers and mass storage devices are manufactured by, for example, Compaq®, IBM®, and Sun Microsystems®. Server 14 runs an enterprise operating system such as Sun®, Oracle Solaris® or the like, and uses a standard HTTP server, such as Apache®.

ASP LAN 17 is a plurality of ASP clients 13 clustered together to handle more client traffic and including one or more mass storage devices such as a disk farm or a redundant array of independent disk (“RAID”) system for additional storage and data integrity. The ASP local area network 17 (“LAN”) interconnects ASP clients 13 through a hub 15 (for example, a peer network such as a wired or wireless Ethernet network) or a local area network server (in, for example, a client-server network). The ASP LAN 17 is preferably connected to the internet 11 through a secure gateway 16, which provides security to the ASP LAN 17 and ensures operating compatibility between the ASP LAN 17 and the internet 11. An exemplary ASP client 13 may include a processor, a memory (e.g. RAM), a bus which couples the processor and the memory, a mass storage device (e.g. a magnetic hard disk or an optical storage disk) coupled to the processor. At least one ASP server 18 in ASP LAN 17 is a database server running database management software to provide database services to ASP LAN 17 and user clients 12 and servers 14, as defined by the ASP client-server model. Database management systems frequently provide database server functionality, and some DBMSs (e.g., MySQL) rely exclusively on the client-server model for database access. Thus, ASP server 18 preferably hosts a network database preferably an SQL server database, running MySQL. Other examples of Database servers are Oracle, DB2, Informix, Ingres, SQL Server. Secure communication lines are used between clients 12, servers 13 and ASP LAN 17 so that private data remains so.

The secure gateway 16 may be a Citrix Access Gateway® for securing the delivery of the virtual workspace and populating data to user clients 13 and servers 14 anywhere, and which provides security to the ASP LAN 17 and ensures operating compatibility between the ASP LAN 17 and the internet 11.

The ASP server 18 hosts a hosts a web server which delivers the virtual Workspace by transmitting web pages in hypertext markup language (HTML) or extensible markup language (XML) (or a similar scheme) using the hypertext transport protocol (http) to any of clients 12, 13 or servers 14. The ASP server 18 also hosts the network SQL database which is populated with diverse “data entries” such as To-Do items, emails, contacts, etc., all tagged with Metadata providing information about the data entries, as will be described.

Given the foregoing architecture, for purposes of explanation the following terms are herein used to describe system operation.

“Workspace”. This term defines the individual virtual workspace of the user, also referred to as “My Workspace”. It contains the tree of all areas, all the folders and all the sub-folders associated with a given user who is either the owner of said Workspace, or has been granted Guest user permission to same.

“Entry”. Refers to a “record”. A folder/sub-folder in the Workspace consists of entries. For example, the “My Notes” folder consists of entries, representing distinct “Notes”.

“Data Field (DF)”. Data Fields (DFs) are used for data entry throughout the various folders/sub-folders within the user's Workspace. DFs are of different types. An entry in a folder/sub-folder comprises one or more DFs. For example, an entry in the “My Contacts” folder may include the following DFs: “First Name”, “Last Name”, “Address Line 1”, “Address Line 2”, “City”, etc.

Data Field Type (DFT)”. Data Field Type defines the type of DFs, such as “String”, “Memo”, “Number”, “Reference”, “File Attachment”, etc.

“Folder Template (FT)”. Contents of folders and sub-folders are viewed using a tabular view of the entries, where each entry is presented as a row in said view. A tabular view of a given folder or sub-folder displays all the entries of said folder or sub-folder. Each row in said tabular view displays entry specific values of selected DFs, with corresponding columns heading across the top of the table showing the label (name) of said fields. The Folder Template (FT) defines which DFs to use in said display. In addition, the FT defines additional attributes that are specific to the given folder or sub-folder, thus defining the overall desired behavior of said folder or sub-folder. In the present invention these additional attributes include, but are not limited to, “Entry Title (ET)”, “Search Fields”, “Copy Fields”, etc. The present system allows specifying specific column headings and desired attributes for each FT, and using different FTs for different folders/sub-folders.

“Data Entry Form (DEF)”. When viewing contents of a folder/sub-folder using the tabular view, the user may select to see all the data of a given entry (a row in the table). The display of the content of an entry in a folder/sub-folder is facilitated through a Data Entry Form (DEF), which defines: (i) which DFs are used for a given folder or sub-folder, and (ii) how said DFs are displayed (organized) on the screen when the user creates, views or modifies an entry.

“Form Editor”. This is an essential system user interface (GUI), which facilitates the creation, definition, and modification of DEFs. Within a given (new or existing) DEF, the Form Editor enables the user to create DEF Tabs, DEF Sections, the specific DFs to be included in each Section, and their position in any desired Section/Tab. The Form Editor maintains the collection (“library”) of all DFs for a given folder or sub-folder, allowing the user to add, modify, or remove DF from said collection. The creation of a new DEF as well as maintenance of an existing DEF is based on user friendly drag-and-drop. The DEF also provide the ability of displaying entry linkage information on the form, for instance, the ability to open an email, see if it is “linked” to a to-do item, which may be another entry in the given Workspace; view that to-do item, and if the to-do item is further linked to a document, or a contact, the system provides the ability to view that corresponding object as well. This entry linkage facilitates some of the key elements the present system and provides for integration among different areas of a user's Workspace.

System Overview

The present system is a cloud-based system for high performance integration, processing and searching of structured and unstructured data in a tree structure of folders and sub-folders containing entries with data, with user-friendly column headings and data forms, providing users with simple, intuitive, unified methods and central data management of structured and unstructured data, instant search and location of anything. The system provides means allowing the users to modify and expand their Workspace to fit their specific needs, including full customization capabilities to create new folders, sub-folders, and control of the display formats and data fields required to manage their data. The system includes a platform for selectively sharing user data via social networking and/or curated databases by experts who provide authoritative data, which using the present system, can be shared with the general population of all users, who can view, use and rank said expert data. The system offers a centralized way for users to “manage their lives”, i.e., their “daily agenda”. The system includes an improved web-enabled database tree structure capable of storing all structured and unstructured data users need to deal with on a daily basis, plus a robust toolset that allows users to: (i) store, retrieve and manage data of all sorts, including (i) documents. (ii) email, (iii) notes, (iv) to-do-items (TDIs, tasks), (v) calendar items, etc. The system facilitates efficient “full text” and indexed searches allowing the user to quickly find anything they are looking for in their Workspace, without having to remember what they stored and where. The system is a more efficient way of managing all areas, data types, topics and tasks related to users' household and personal life, as well as work related needs, such as contacts, correspondence, purchases, meetings, areas of interest, leisure, properties, etc. In addition to unified access and methods to manage data and activities, the system offers full integration among all relevant structured and unstructured data, including email, documents, activities, calendar items, etc. All data elements are treated as entries in the Workspace, and the system provides effective means to link among all relevant entries, and query/manipulate linked entries. Using this linkage, and as previously mentioned, the user can effectively recall any and all entries, regardless of form, originating from a previous train of thought. For example they can identify a task which was created as a result of reviewing a document, or a note stored as a separate entry in their Workspace. This “connectivity” and integration benefits users substantially, as they can make better informed decisions and take actions that are more effective when the various pieces of data are readily available through a unified Workspace, and when all relevant aspects of managing their personal, household and business matters are “connected” to each other. Furthermore, using the unified access offered by the system, and the structured tree-based database hierarchy where entries (including objects and documents) are stored in the system in data fields (DFs) earmarked by “metadata” indicating one of a plurality of predefined categorical DF types, the present Workspace allows the user to easily search an locate pertinent entries regardless of the type or purpose of the data, time or date of creation, means of creation, author of the data, or location on the computer network (all the conventional queries used in a conventional folder/sub-folder database hierarchy).

For example, a user may store all of his/her pictures (unstructured data objects) in his/her Workspace under a folder named “My Pictures” and use relevant sub-folders, such as “Family”, “Work Related”, and “My Baseball Team”. Then, using DFs, such as “Subject”, “Location”, “Date Taken”, and “Persons in Picture”. Thus, for example, the user can then search his/her Workspace to locate all entries relevant to “Mary White” to find all pictures where she is one of the “Persons in Picture”, as well as all other related objects, such as emails (where “Mary White” is the “Sender”), and documents where “Mary White” is the “Author” (in this example, the “Sender” and “Author” are DFs defined for “My Email” and “My Documents”, respectively).

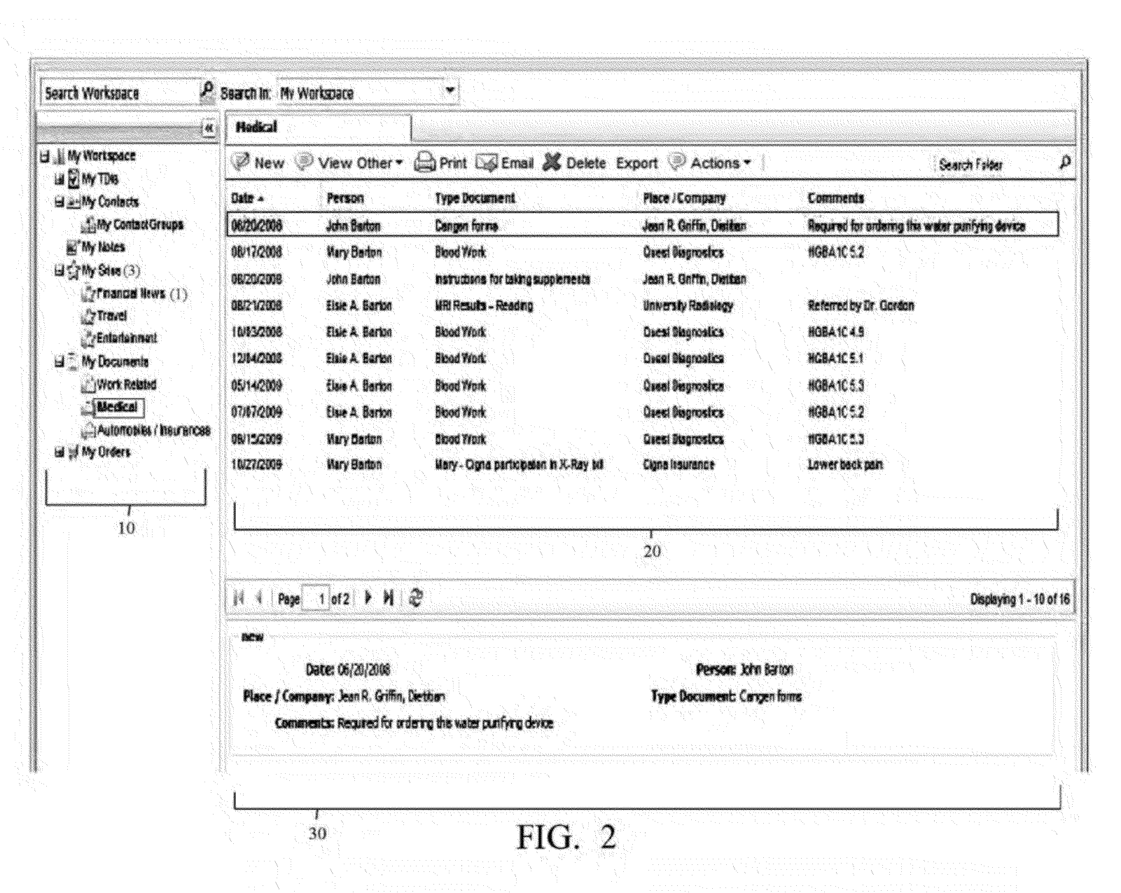

FIG. 2 is a screen capture of an exemplary user virtual Workspace according to the invention. The Workspace includes a Tree-view Pane 10 at left arranged and displayed in a “tree-view” structure including a top node designating the Workspace (My Workspace), and a plurality of folders linked to the top node, a plurality of sub-folders linked to each folder, and so on. Each folder and sub-folder also has a visible indication (+) showing the node where the folder or sub-folder can be “opened”; i.e., whether it has any sub-folders in it. The user may select any top-folder or sub-folder by click-selecting the corresponding node on the tree. The entire Workspace can be collapsed to show (i) just the very top node; (ii) all top-folders; or (ii) to expand any nodes to any extent (level) desired, thereby viewing any sub-folders beneath same. To assist, when moving over the Tree-view Pane 10 of folders and sub-folders, the cursor shows a pointing hand at each node/folder/sub-folder. “Expand/Collapse” is achieved by the user left-clicking on the given tree node, or by right-clicking which yields a Tree-view Right-click Menu with a “View Folder” option to expand or collapse to show (i) just the very top node; (ii) all top-folders; or (ii) to expand any nodes to any extent desired, thereby viewing any sub-folders beneath same.

As will be described, the Workspace is initially populated with a set of default folders/sub-folders (as shown) but is completely user configurable to delete existing and/or define additional folders/sub-folders.

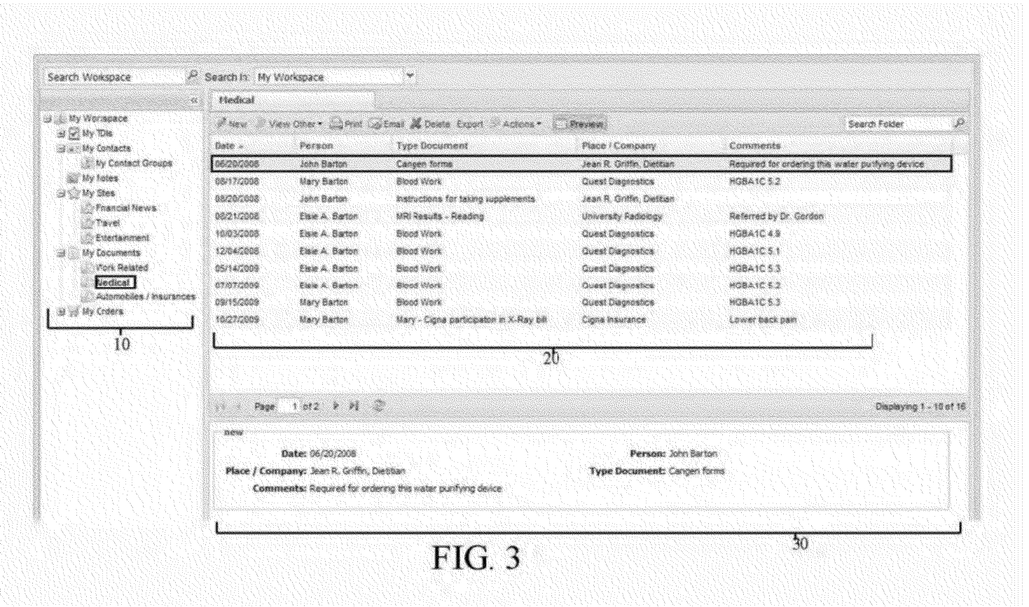

FIG. 3 is a screen capture of an exemplary user-populated virtual Workspace according to the invention. When populated, each folder and sub-folder displays a “count” (see, e.g., FIG. 3 “My Sites” and “Financial News”), which corresponds to the number of entries currently in the folder or sub-folder. The illustrated example shows a “Medical” sub-folder as a sub-folder of the “My Documents” top-folder. The Medical sub-folder may be “selected” (bolded) by clicking on the Workspace Tree-view 10 on the left, and this engenders a Workspace Tabular-view Pane 20 in which the system displays all the entries of the selected folder or sub-folder.

The Tabular-view Pane 20 is a tabular view, with column headings across the top, and each entry represented as row in a table. Tabular-view Pane 20 includes data fields (DFs) labeled by “column headings” associated with the selected folder or sub-folder. With the Medical sub-folder selected, exemplary column headings comprise the “Date”, “Person”, “Type Document”, “Place Company” and “Comments” data fields (DFs). A row in Tabular-view Pane 20, i.e., a given Entry, may be “selected” (bolded) by clicking on that row in Tabular-view Pane 20, and this engenders a Workspace Preview Pane 30 at bottom. In FIG. 3 the first entry in the Medical” sub-folder for “John Barton”, “Cangen Forms”, etc. is shown as the selected entry in Tabular-view Pane 20. As a result of this, preview Pane 30 at bottom displays a summary of the data of this given entry. The tabular-view Pane 20 shows the entries sorted by the “Date” DF, using ascending order (indicated by the UP arrow proximate the date). The combination of left Tree-view Pane 10 and split-right Tabular-view Pane 20 and Preview Pane 30 is an essential aspect of the present invention.

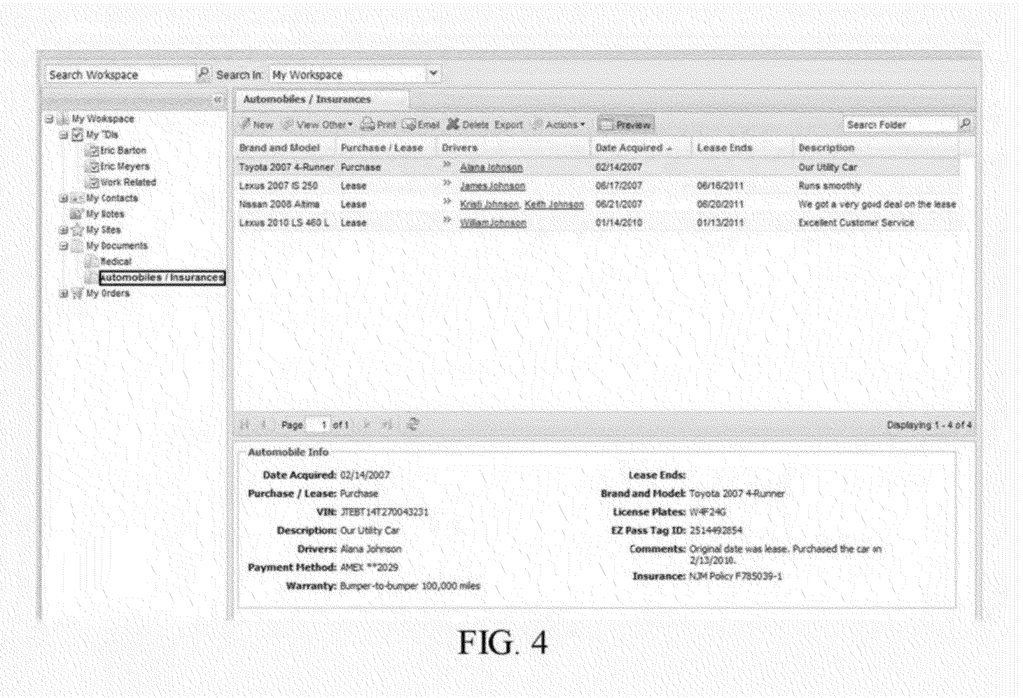

FIG. 4 is a screen capture of the same user's Workspace of FIG. 3 with the “Automobile Insurance” sub-folder of the “My Documents” top-folder selected from the tree-view Pane 10 at left. This selection changes the “column headings” used in Tabular-view Pane 20 which now comprise the “Brand and Model”, “Purchase/Lease”, “Drivers”, “Date Acquired”, “Lease Ends”, and “Description” data fields (DFs). Also note that the “Drivers” data field (DF) shown in the Preview Pane 30 is an underscored “Reference” type DF (explained below), which is a clickable “pointer” to another record entry in the Workspace, in this case pointing to the corresponding entry under “My Contacts”, a separate folder where all persons with their contact and other information are maintained. A Reference type DF may contain one or more values, each pointing to a different entry in the Workspace.

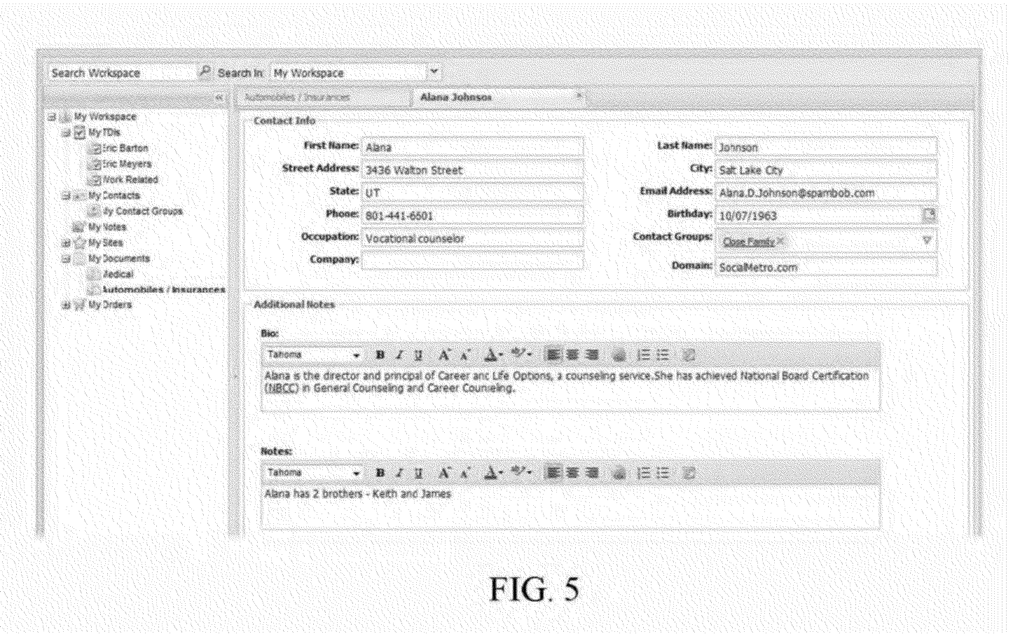

Data in most folders/sub-folders is stored in the SQL Server 18 database in data fields (DFs) which represent the smallest subdivisions of the stored data that can be accessed. All DFs are accessible by a URL-based (uniform resource locator) addressing scheme. As described in more detail below, each DF is identified or “tagged” with Metadata including an attribute called a “Data Field Type (DFT), which defines the type of data in that DF. A “Reference” DFT may contain one or more individual values where each is referring (“pointing to”) some other entry in the user's Workspace. In FIG. 4, each “Reference” type DF is a pointer that contains the URL for another entry (record) in the Workspace. Being a “pointer”, the values under the “Drivers” in the Workspace Tabular-view Pane 20 are shown as hyperlinks, allowing the user to click on any and see the detailed information of each such record entry, which in this case, are entries of the “Contacts” folder. Clicking on the pointer e.g., Toyota 2007 4Runner, displays the detailed information of the corresponding insurance policy in a separate (newly created) tab next to “Automobiles/Insurances”. Then, clicking on the pointer “Alana Johnson” in the Preview Pane 30 of FIG. 4 drills down to the screen of FIG. 5, displaying Alana's Contact information in a separate tab with the more detailed in the Preview Pane 30, in accordance with a Data Entry Form (DEF) assigned to the “Contacts” folder.

The Workspace Tabular-view Pane 20 and the Preview Pane 30 display all DFs in accordance with predetermined “data entry forms” (DEFs) which are assigned to each folder and/or sub-folder where these DFs reside. The assigned DEF controls the display of the content of an entry in a folder/sub-folder when viewed in “full view” in a separate tab, as well as the display of the DFs in the Preview Pane shown in the Tabular View when a given entry is selected. More specifically, each DEF defines (i) which DFs are used for a given folder or sub-folder, and (ii) how said DFs are displayed (organized) on the screen when the user creates, views or modifies an entry. When the user clicks-selects a different node (folder) on the Tree view of the Workspace, the Tabular view will reflect the FT assigned to said folder or sub-folder, the Preview Pane will reflect the given DEF assigned to said folder or sub-folder, and when the user selects a given entry to be displayed in “Full View” in a separate tab the display will correspond to the DEF assigned to said folder or sub-folder as well. Thus, for example, if a user clicked on the “Medical” sub-folder of FIG. 4, the Workspace Tabular-view Pane 20 would change back to that shown in FIG. 3 to display the contents of the Medical sub-folder using the DEF assigned to that folder (where this given entry resides).

The above-described Virtual Workspace database hierarchy (DFs representing the smallest subdivisions of the stored data and accessible by a URL-based addressing scheme, tagged with DFT metadata defining the type of data in that DF, and FTs and DEFs assigned to each folder and/or sub-folder for controlling the display of DFs and maintenance of values thereof), facilitates a graphical user interface, plus an integrated suite of management tools described below which allow users to organize and manage all their data including emails, contacts, bookmarks, tasks, documents, notes, purchases, projects, and all other relevant information in a more centralized and efficient manner. Specifically, the system provides the following advantages:

Eliminates the need to manage and rely on disparate and numerous data repositories since all forms of data, such as email, documents, contacts, to-do items, etc. are uniformly stored and uniformly accessible in a single database.

Fully customizable workspace, provided individually for each user, with a structure and mechanism that allows users to utilize their individual Workspace to address their specific needs, including the ability to create folders, sub-folders, customizing the display of same, defining DFs “on the fly”, control the display of individual entries, specifying inter-folder relations, and defining a variety of custom rules.

Full integration among all related components, including email, calendar, contacts, notes, tasks, as well as actions taken thereon.

Reduced physical storage overhead cost through eliminating data redundancy.

Reduced time required for managing the “daily agenda” through improved efficiency (i) using same UI to manage all sorts of data; (ii) effectively viewing and handling of all data using folder and entry specific display, which is optimized to the various types of data; (iii) effective “full text” searches to quickly locate anything users are looking for regardless of the nature of the data as all reside in one place; (iv) the ability to view all related data and activities, providing the necessary context to get things done in a most effective fashion.

Avoids incomplete searches and “missing in action” data and activities;

Allows one secured centralized location for all data and documents, accessible anywhere, through the Internet, with ASP-provided backup and disaster recovery.

Seamless social networking including sharing and transferring of all data, documents and activities.

The user interface, management tools, data constructs and use thereof are herein described below in more detail.

My Workspace

Referring back to FIG. 3, My Workspace is a user's individual virtual workspace, e.g., a “personalized desktop” containing data pertaining to everything a user needs to manage their daily agenda, such as personalized data, documents and actions, as well as the same for managing households and businesses. From the Tree-view Pane 10 tree-view of all folders and sub-folders as described above, users are able to “expand”, “collapse” and open a “summary” view of all entries within each in Tabular-view Pane 20, and within the Tabular-view the user selects any entry (row in said view) to view a “summary” of said entry using the Preview Pane 30. The user can also see all the information (all DFs) of any selected entry so that all the data of such entry is displayed in its own tab using the DEF assigned to the given folder/sub-folder where said entry resides; this is considered the “Modify View”, where the user can also modify any desired data (DFs). The system provides the user with effective means to (i) create new folders and sub-folders, (ii) create new entries in any given folder/sub-folder, (ii) view said entries, (iii) modify data by modifying the values of DFs in said entries; and (iv) delete entries. All data within a Workspace is both displayed and manipulated using unified methods. For example, opening the “My Contacts” folder, viewing entries thereof and handling data employs the same methods and interface as when the user opens up any other folder, such as “My Email”, “My Favorite Sites”, or “My Books”. The unified structure simplifies the way users save, manage and locate everything they need to handle their daily agenda, household, estate and business needs. For instance, user may perform a single search and find all email messages, to-do items and documents pertaining to a certain account or service provider because they all reside in the same Workspace.

Folders/Sub-Folders

Initially, a set of default folders and sub-folders is defined and setup in the user's Workspace based on user preferences defined during registration. Afterward, defining additional folders/sub-folders/preferences and thus, auto-populating additional entries, can be performed by the user at will. The following is an exemplary set of folders/sub-folders within the user's overall Workspace. Each folder can be further divided into sub-folders, which can be further divided into next-level sub-folders, indefinitely, so a user can add as many user-defined folders and sub-folders as needed.
My Email
   Unread (list of unread email, regardless of area)
   Friends
   Work
On-line shopping
   Travel
   Finance
My Recent
   Email
   TDIs (to do items)
   Documents
   Notes
   Sites
My TDIs
   Email related (where response may be needed)
   Orders
      Electronics
      Cameras &. Accessories
My Contacts
My Documents
My Properties
   200 Main St., Hackensack, N.J.
   915 Madison St., Hoboken, N.J.
My Books
My Log
My Recent
My Reminders
My Dashboards
My Triggers

With reference to the My Properties folder, it can be seen that the DFs assigned for this folder are: “Address Line 1”, “City”, and “State”. Other DFs assigned for this folder may be “Address Line 2”, “Zip Code”, “Zip 4”, and “Status” (such as “Rented” and “Vacant”). The ASP may offer recommended folders/sub-folders and specific pre-populated entries for inclusion in the user's Workspace based on continuous research and/or user feedback. For example, for a defined folder of websites of interest entitled “My Sites”, the ASP may recommend new sites for research, shopping and overall areas of interest. Similarly, for “My Books”, the ASP may recommend new published books, based on the user defined areas of interest.

Data Fields (DFs)

As indicated above, data in most folders is stored using data fields (DFs) which are the smallest subdivisions of the stored data that can be accessed. Each DF is identified or “tagged” with Metadata including an attribute called a “Data Field Types (DFT)”, which defines the type of data in that DF. The following are the categorical DF Types (DFTs) currently used in the preferred embodiment, which appended explanations:
String
Encrypted String (stored in the database using AES 128 or AES 256 encryption)
Email Address (values entered in this DFT undergoes validation to enforce valid email format)
Multi Email Addresses (same as above, but allowing to enter multiple values)
Memo (text area)
Selection (single selection dropdown; users can customize the values available for each Selection DF—add, modify, and delete).
Multi-Selection (multi-selection, same as the above, but the user may select more than one value, e.g., “Property Type of Interest”—the user may select “Condo” and “Townhouse”
Number (accepts digits only)
Decimal (accepts digits and decimal position)
Currency (when displayed—shown with the currency sign, other than that, behaves like Decimal DFT)
Date
Date/Time
Reference (referencing a single Entry anywhere in the WS, e.g., a Task having an “Originating Email” as a Reference DF, which can be used to “point” at the email that originated said Task.
Multi Reference (same behavior as above, but can have multiple values, each pointing a at a different Entry in the WS, for example, “Correspondence” DF, which points at all the emails received or sent for a given Entry in the “Orders” folder.
Email Multi-value Reference (having one or more values, each pointing at an Entry in a given folder, and furthermore, pointing at a given Email Address DF within that Entry. Example, the “Group Members” DF in “Contact Groups” will have one or more values, each pointing at an Entry in the “Contacts” folders, and each such value specifically identifying a given Email Address DF, such as “Personal Email”, “Work Email” etc. This way, a given Contact Group can be used as the destination of sending an email, where each of the recipients will be a given contact and the desired email address for that given contact (as contacts may have one or more email addresses).
Web Search (a field that allows the user enter searches (keywords); the ability to save same—so that the next time this Entry containing this DF is displayed, the user sees the keywords used last; plus the ability to launch the user's preferred search engine, e.g., Google, to use said keywords to search the web and to display the corresponding results, etc. Saving such searches (selected keywords and phrases) and having the ability to re-execute same at a later time provides the user the ability to repeat successful searches with the assurance that as content on the worldwide web changes that said searches will yield consistent and up-to-date results.
File Attachment (may have one or more values, where each is a file or an object that has been uploaded to the user's WS, and is “pointed to” by said value(s). Such files/objects can be of any type, including Word, Excel, jpg, video, etc. file. This DF is a variation of a Reference DF, where instead of “pointing to” another Entry in the user's WS, it points to an object stored internally in the IQTELL database on behalf of the given user)
Checkbox (a single-value DF type with possible values of “Checked” and “Unchecked”, like in “True” and “False”.
URL (can contain one or more values; each having a “Title” and an actual URL, pointing a specific element located on the Internet, e.g., a website, or a specific object, etc.

Depending on the DFT assigned to a DF, when data is entered in that DF the present system automatically validates the entered data. Specifically, for instance, if it is an Email Address DF, the system will validate that a valid email address format is being entered. In a separate case, when the user enters an Email Address in a given DF, such as “To”, “Cc”, or “Bcc” when composing an email using the present invention, the system automatically searches the “My Contacts” and the “Contact Groups” sub-folder underneath, looking to match the entered value with “Email Address” type DFs to facilitate the “Auto Complete” mechanism offered by the system, as well as to ensure the selection of existing valid email addresses. As explained above, DFs are displayed in accordance with predetermined “data entry forms” (DEFs) which are assigned each folder/sub-folder.

The Selection DFT has an additional specifying whether the Selection DF is a “Single-value Selection” or a “Multi-value Selection” DF. In any case of a “Selection” type DF, the user can define his own possible selection values (choices) for this field, e.g., define a “Service Quality” Selection type DF with choices such as: “Excellent”, “Good”, “Fair”, and “Unsatisfactory”. The user can also define additional selection values to existing “Selection” DFs as well as modify existing selection values. If a Selection DF is flagged as a single-value selection the user may select one value at a time, e.g., “Blue”, or “Red.” If a Selection DF is flagged as a multi-value selection the user may select multiple values, e.g., “Dresses”, “Outerwear”, “Jeans”, etc. (useful when describing entries under “My Vendors”, or “My Sites” has to offer).

The Reference DFT is essential to the integrated nature of the present system. The Reference DF type may be a “Single-value Reference” having just a single value, or a “Multi-value Reference” having one or more values. Each value of a Reference DF can be (i) pointing at another existing entry in the user's Workspace, pointing at a TDI (a task), an entry in the “Documents” folder or sub-folder, an Email, a Contacts, etc; (ii) a URL pointing to anywhere in the Worldwide Web, and (iii) a link pointing to an independent object, such as an image, a video clip, or a document, which has been uploaded and stored in the system database. Each of the values stored in a Reference DF has three components, designated (i) Object Label, (ii) Object Title, and (iii) Object Reference. The Object Label is an optional parameter describing the given value in the context of the given DF. The Object Title is a string representing the object being pointed-to, e.g., “Mary White”, which in this case is a person's name, i.e., the pointed-to entry in the “Contacts” folder. The Object Reference is a URL,—it is an internal value stored for every value of a Reference DF providing the “address” of the object that is being “pointed to”. As an example for the Object Label, a Multi-value Reference DF under “My Properties”, named “Contacts” may define contacts associated with a given Property such as “Tenant”, “Broker”, “Association Rep”, “Plumber”, and “Electrician”, consequently, the user may assign a label for each such value, in this case a contact, with a corresponding label, so that instead of just displaying values such as “John White”, and “Mary Stevens”, said Reference DF will display “Tenant: John White”, “Association Rep: Mary Stevens”, etc.

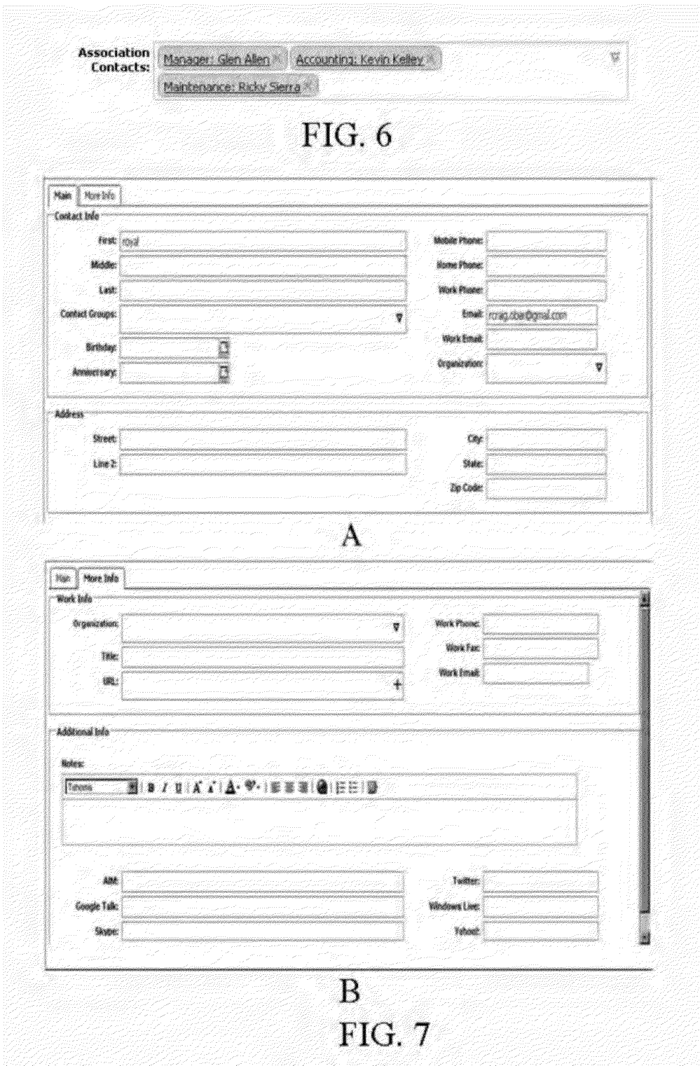

FIG. 6 is an example of a Multi-value Reference DF showing an Object Label: “Association”. As described above, the Object Label is used for display purposes—conveying to the user which object is stored corresponding to each value entry of a Reference DF; in this example there are three contacts Allen, Kelly and Sierra, however, values of a Reference DF can point to any entries within the Workspace, e.g., “Invoice No. 1234”, “Letter to the Association”, “Follow-up Call”, etc. In the latter case, the object “pointed to” is a document where the Object Title represents the filename. When the Object is a reference to another entry in the user's Workspace, the Object Title will be the Entry Title (ET) of the referenced entry. The Object Reference is a system internal value—a “pointer” to where the given object is stored—it is used by the system in handling the retrieval and storage of objects. It is not displayed to the user. The Object Reference can be (i) a Web URL, (ii) a pointer to an entry in the user's Workspace, such as an entry in “My Documents”, “My Notes”, “My Email”, etc. or (iii) a pointer, i.e., the address, of an object stored in the system database (an uploaded file such as an image, a document, etc.). While the Object Reference may be “pointing” at a specific entry in the Workspace, it can also further specify which DF in that entry it is referencing. An example of the latter would be a reference to an entry in the “contacts” folder, i.e., a reference to a given contact, in which case, such reference may point to a given Email Address DF within said contact, such as the “Personal Email” or the “Work Email”. Such a “compound” reference, i.e., a given entry and a specific DF within said entry is useful, for example, when referencing contacts and specific email addresses to be used when referencing entries in the “My Contact Groups”—thus, when sending email to a given Contact Group, the system will know which specific Email Address to use for each contact in said Contact Group when sending the email (see also “Multi-contact Entries” under “My Contacts”). In certain special cases the Object Reference is set to NULL, such as when setting values for the “Sender”, “To”, “CC”, and “BCC” Reference DFs when handling email where the recipients have not yet been “connected” with corresponding entries in the “Contacts” folder, i.e., when receiving or sending email messages where the designated email address is not yet resolved, i.e., not matched with a corresponding entry under “My Contacts”, the Object Reference will be set to NULL, and the Object Title will be set with the given email address, e.g., “john966@gmail.com”.

The Email Reference DF type (DFT) is a variation of the above-mentioned Reference DF type. It is used specifically to reference an entry under “My Contacts” and specifically, “pointing” at a given Email Address type DF (as previously explained). The Email Reference DFT is needed since entries in the “My Contacts” may have more than a single Email Address, and so using this DFT allows the user to select the desired Email Address(es). This DFT is used specifically when building entries under “My Contact Groups”, where each group specifies a, number of contacts, and for each, the desired email to be used when creating outbound email messages.

The URL DF type is similar to the Reference DFT and may be used as a: (i) Single-value URL, or as a (ii) Multi-value URL DF type. The URL DFT is used to reference websites and web pages. A URL DFT has two principal elements (i) Object Reference, and (ii) Object Title. The Object Reference contains the actual URL, such as http://www.levoltz.com/2009/07/2.3/5-things-to-look-for-when-buying-a-digital-camera/. The Object Title contains the title of the corresponding URL page, e.g., “5 Things to Look For When Buying A Digital Camera, Levoltz”. The system allows the user to modify (edit) the Object Title, so that the user can customize the Object Title to fit his/her needs. Whenever a URL DFT is displayed in conjunction with any entry in the Workspace, it is shown as a hyperlink, allowing the user to click such link and the system to automatically launch the user's default web browser in conjunction with any given URL DF. Once the web browser is launched, the user may view that given website or specific web page, as well as use that entry point to continue and “surf” the web, as needed. Once positioned on a given site, reflecting an area of interest, such as an article, product, an interesting site, or any link within a given web page, the user can bookmark the corresponding URL by ‘right-clicking’ off that page or link, which invokes a “plug in” installed on the user's computer, that automatically populates the URL DF where the browser was invoked from and consequently, the URL and <title> values corresponding to the given page, will be used with the present URL data. This feature is quite useful when considering the fact that a URL DF can contain one or more values, i.e., one or more URLs.

The Web Search DF allows the user to (i) enter and save keywords and search phrases, and (ii) launch the user's default search engine, such as Google, Yahoo, Bing, etc. to uses said keywords and search phrases to actually launch a search. Certain keywords or a certain phrases may be more “productive” than others, i.e., achieving better results to fit a specific search needs of the user, and thus, the ability to save these searches for repeat use can be quite beneficial as the user doesn't have to remember which keywords or phrases worked best previously. The Web Search DFT also provides a mechanism to record any selected items from the result set corresponding to such searches. The saved content of Web Search DFs, allows performing repeat web searches. For example, the user can modify the content of the given DF; launch a web search based on the modified content; and then decide whether the search results are better or worse, compared with the previously used keywords or search phrases. Based on his/her decision, the user can then save the modified content of the given Web Search DF. Note that any given URL DF within a given DEF can be “related” to a given Web Search DF on said DEF. The purpose of using a Related URL DF is for accepting and storing URL information corresponding to the results of such web searches. Following a search invoked from a given Web Search DF, results will be displayed within the browser. Reviewing these results, the user will be able to select which corresponding URLs should be stored in a Multi-value URL type DF. Thus, whenever the user reviews the given entry, containing the given Web Search DF, s/he will also be able to view and use the selected results corresponding results in the Multi-value URL DF.

Search DFs define which DFs to use when searching through a folder or sub-folder when performing Automated Searches (described further below).

The above and the description under DATA FILEDS (DFs) describe the principal data field types (DFT) currently used in the preferred embodiment. One skilled in the art should understand that other DFTs may be defined as needed. All DFs used in the system comprise the user's “library” of DFs. All DFs in the user's library are available when building and configuring FTs and DEFs in each such top-folder, as well as in any sub-folders. If desired, an entire “library” of DFs may be assigned for each top-folder in the Workspace, which then becomes available to any sub-folder thereunder.

DEF Creation

As described above, DEFs define: (i) which DFs are used for entries in a given folder or sub-folder, and (ii) how DFs are displayed (organized) on the screen when the user creates, views or modifies an entry (in what we previously described as “Full View” and “Modify View”). For each DF defined in a DEF the following attributes need to be specified: (i) the DFT, (ii) a label used as the “DF Name”, which is displayed next to the DF, and (iii) the location (x-y position) where said DF should be displayed within a given DEF. The label assigned to a DF is also used when displaying entries of a folder or a sub-folder in Tabular-view, where said labels are displayed as the column heading of said display. DEFs can be created or modified directly through by use of a Form Editor. In addition to the user-defined DFs there are system-defined (intrinsic) DFs, including (i) Date/Time Last Created, (ii) Date/Time Accessed, (iii) Accessed By (which user), (iv) Date/time Last Updated, and (iv) Updated By (which user), all of which Date/Times DFs pertain to an entry that was created, displayed, or modified. These System DFs are displayed as read-only text information. There are also System DFs used for TDIs (tasks).

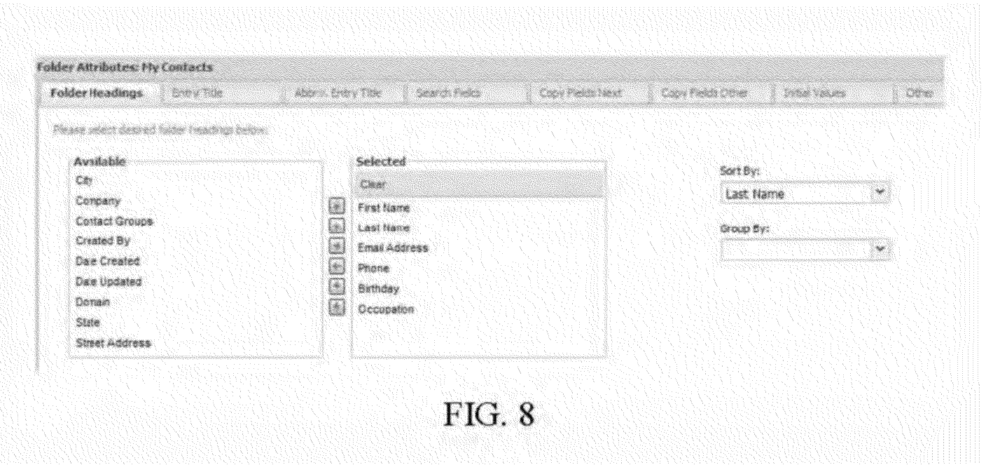

FIG. 7 (A&B) is a screen capture of an example DEF opened in the DEF Form Editor, showing an entry in the “My Contacts” folder. Each DEF may comprises one or more tabs, each tab comprising one or more sections, and each section comprising one or more DFs of any desired DF type (DFT). This particular DEF uses two tabbed “sections” A & B with a variety of DFs in each describing “royal”. The DEF Form Editor gives great flexibility in the creation and modification of DEFs. It facilitates the (i) definition of new tabs, new sections, and new DFs; (ii) positioning of sections with any tab and the positioning of DFs within any section; (iii) ability to remove any tab, section, or DF; and (iv) the ability to modify the name of any tab, section, or DF. The Form Editor provides an efficient drag-and-drop mechanism to position sections and DFs with sections. The definition of a DEF is completed after all of the above have been specified/defined, with defining the Event Date/Time and the Event Additional Information DFs as optional. All defined DEFs are stored in a DEF library for reuse. Every folder and sub-folder in the workspace is assigned a corresponding DEF.

Assigning DEFs to Folders.

When creating a new folder, the user can create a new DEF “from scratch” and assign it to the newly created folder. Alternatively, the user can choose an existing DEF from the library of existing DEFs to be assigned to the newly created folder. The same applies for sub-folders. When creating a new DEF, the user invokes the Form Editor by right-clicking a newly created top-folder, or an existing folder or sub-folder. In which case, the Form Editor will be used to create (define) a new DEF, which is then automatically assigned to said new folder. If a DEF is already defined for the given folder or sub-folder, the Form Editor can be used to view the existing configuration and modify it as needed. When the user creates a sub-folder in a given folder (a “Parent Folder”), the system automatically uses the DEF of Parent Folder to be assigned to the newly created sub-folder as well. The user can then apply changes to the DEF as needed. If the user modifies a DEF of a sub-folder such operation will have no impact on the DEF used by the Parent Folder or other sub-folders at that level, however, in the preferred embodiment, said changes may be carried over to DEFs assigned to sub-folders, which use the DEF that was modified.

Folder Templates (FTs)

For newly created folders, the user must specify the DEF (described above), and a “Folder Template” (FT) which defines all the folder attributes, including the column headings, which are the DFs to be used when displaying the contents of a folder/sub-folder in the Tabular-view (FIG. 2). For example, consider the following entries under the “My Contacts” folder:

| First Name | Last Name | Company Address | City | State | Phone |
|---|---|---|---|---|---|
| “John” | “Doe’ | ‘ABC Corp’ 400 Main St. | Miami | FL | (305) 123-4567 |
| “Mary” | “White” | “Smith, Inc 915 Elm St.” | Hoboken | NJ | (201) 432-8765 |

Each FT defines the DFs to be used and their order, i.e., the column position: 1, 2, 3, etc.

FIG. 8 is a screen capture of an FT definition used by the “My Contacts” folder that illustrates how DFs may be selected from the set of all DFs used in the DEF assigned to the “My Contacts” folder. Using the FT definition the user must specify the following attributes, grouped by the top tabs of the FT definition form, and which are listed as follows:
the folder headings , also referred to as “Column Headings”;
the “Entry Title (ET)”, i.e., which defines which DFs constitute the ET (including any ch's that can be used to concatenate the DFs, such as space “ ”, or hyphen “-”, etc.). The ET is used when a given entry in the user's Workspace is displayed by way of reference. See more detailed description below;
the “Abbreviated Entry title (AET)”, which is defined in a similar fashion to the way the ET is defined. The AET is used in a similar way to that of the ET, but typically, it is a shorter version. See more detailed description below;
the “Search Fields”, i.e., defining which DFs should be used when searching for matching entries in a given folder or sub-folder. Example, First Name and Last Name would be reasonable Search Fields for the Contacts folder, i.e., if the user searches for “Craig”, he'll find all contacts, i.e., Entries in “Contacts” folder, where the first name is “Craig”, etc.
the “Copy Fields Next”, defining which DFs will automatically be copied over from a given Entry when creating a new Entry off said Entry within the given (same) folder, e.g., when creating a Next Entry in the “Phone Calls & Conversations” folder off an Entry with a Subject=“Inquiring Utility Bill”, and if the Copy Fields Next includes the “Subject” DF, then this subject, i.e., “Inquiring Utility Bill” will be automatically copied over when the user creates a Next Entry based off said Entry.
the “Copy Fields Other”, defining which DFs will automatically be copied over when creating a new Entry off an existing Entry in a different folder. For instance, which DFs to automatically copy when creating a Task, i.e., an entry the “Tasks” folder off an Entry in “Notes”?
the “Initial Values”, defining the initial values that certain DFs will be assigned when the user creates a new Entry. In the preferred embodiment the applicable DFTs (DF types) are Date, Date/Time, and Single-Selection DFs. e.g., when creating a Task, the initial value of “Due Date” would be “the then current date+7 days”, the initial value for the “Status” selection DF in a folder called “Candidates”, where a small business may keep track of candidates, maybe “Unprocessed” (which may then be changed by the user to “Performed Initial Phone Call”, “Rejected”, etc.)

Creating and maintaining an FT entails defining all of the above attributes. Using the selected “Folder Attributes” right-click menu item as shown in FIG. 8 as an example. The following describes some additional FT attributes, and expands the description of some of the FT attributes mentioned hereabove:

The “Unit” comprises one or more words, which describe the “nature” of the entries in a given folder or sub-folder. For example: “Contact”, “Order”, “Order Line Item”, “Task”, “Picture”, “Document”, etc. The Unit is used by the system to display meaningful menu items, buttons and messages. e.g., “Create new Email”, “Create Contact”, etc. The “Unit” is automatically set by the system for certain folders as follows: The “Unit” of the Email folder and sub-folders is set to “Email”; “My Tasks” folder and sub-folders - the “Unit” is set to “Task”; “My Contacts” folder and sub-folders—the “Unit” is set to “Contact”.

The Entry Title (ET) is an attribute of FT used for two main purposes: (i) to “nickname” and identify entries in a folder or sub-folder when said entries are referenced elsewhere within the user's Workspace (using Reference type DFs), and (ii) when entries are referenced on the system calendar. The ET is a concatenation of the value of one or more DFs in the given FT. For example, entries in the “My Property” folder may use an ET, which comprises the “Address Line 1” and “City” DFs used in the given DEF; in which case the ET of an entry with “Address Line 1=200 Main St.” and “City=Hackensack”, will be “200 Main St., Hackensack”.

The Abbrv. Entry Title (AET) is similar to the Entry Title (ET). The AET is defined as concatenation of one or more of the DFs defined in a given FT, including the concatenation of the “Unit” defined for the given FT. The purpose of the AET is to be used where displaying a shorter version of the ET is desired. For example, the AET of a given contact, e.g., “Kevin Acosta” may be used as the label of a tab when the given entry is displayed in “Modify View”, which in this case would comprise the “First Name” DF concatenated with the “Last Name” DF Acosta using the “space” character as the separator between the two DFs.

Search DFs are used when searching through a given folder or a sub-folder in the Workspace (see also Automated Searches (described below). By default, the Entry Title is also the Search DF. However, the user may define other or additional DFs to be used as Search DFs. Examples of Search DFs: Using the ET=“Document Title” DF for the “My Documents” folder may be sufficient, e.g., searching for “invoice” would find entries where the ET is “Invoice #1234”. Similarly, searching for entries under “My Contacts” and using the ET of “First Name, Last Name” would be sufficient, as searches such as “Bush” and “George” would find the appropriate corresponding entries. The internal search mechanism, employed by the system, will be using each of the Search DFs, as well as any portion of the search pattern to locate matching entries.

Optionally, the FT may also specify a Date/Time DF to be used as the Event Date/Time DF for the automatic creation and display of entries under “My Log”. Example: The DF used for this purpose in entries under “My Calls” would be the “Date/Time of Call”.

Optionally, the FT may specify a DF to be used to populate other entries in the FT, such as Entry Title (ET) or the Event Additional Information DF, resulting in the automatic creation and display of entries.

There may be other auto-populate FT attributes. For example, “Use Seq. No” is a DEF attribute, which when selected, automatically adds a column designated “Seq. No” to a folder or sub-folder. This is useful when the user wants to organize entries in a folder or sub-folder based in a certain order other than “Date” or “Title”. An example would be using Seq. No in a folder named “My Agreements”, whereby a certain document may be used as the main agreement, and other documents as appendices (or attachments); in which case, the main document would have “Seq. No=1”, and the attachments would have consequent sequence numbers.

The definition of the FT may also specify additional DFs are automatically populated and displayed based on parsing of the contents of the various entries in the given folder or sub-folder. For example: when viewing the “My Email” folder, or any of the sub-folders of same using the Tabular-view, it would be useful to see information such as “Order Number” in entries of said folder or sub-folder containing email messages related to purchases, e.g., “Order Confirmation” email messages. In which cases, parsing will be defined as a search for keywords such as “Order Number”, “Reference Number” and the like. Another configurable attribute of FTs is the ability to specify a “flag” as a column heading, which flag can be set by the user at will, or can be automatically set based on a rule which specifies certain conditions and values of DFs to be used as a “trigger” for setting the flag on the entry level. Another FT attribute is the ability to specify the propagation of a flag from the sub-folder level to the higher up “Parent” folder. For example, if a DF at the sub-folder level has an “important” flag set, the FT at the folder level can specify a “flag” as a column heading. Consequently, even when the sub-folders are “collapsed” the flag will show at the folder level, in which case the user may decide to “open” the said folder or sub-folder to view the corresponding entries and to see which specific entries requires attention. Furthermore, the system allows configuring FTs to optionally specify “highlight” colors to be applied to folders or sub-folders. Most all folders in the Workspace are assigned a given FT, and when creating a new folder the user is prompted to select a corresponding FT (searchable and selectable from the “library” of already defined FTs) or to create a new FT in an ad-hoc fashion by selecting DFs from the set of all DFs used in the DEF assigned to said folder, and the system automatically assigns such newly defined FT to said folder.

All user-defined FTs are added to an FT library. When creating a sub-folder, the FT assigned to said sub-folder is automatically inherited from its parent folder. The user can then modify the FT assigned to the given sub-folder, which will not affect the FT assigned to the parent folder. Each FT can be added to the FT library, in which case, it is assigned a unique name, such as “General To-Do Items”, “Correspondence”, “Bank Transactions”, “Bill Payments”, “Orders”, “Work Related”, “Personal”, etc.

Creating a New Folder or Sub-Folder

Given the above-described data constructs, it will now be described how the system allows the user to create a new folder or sub-folder. When creating a new folder the sequence of steps taken are: (i) browsing to or selecting the folder location within the Workspace, (ii) specifying the desired folder name, (iii) assigning a DEF, and (iv) assigning an FT. By default, newly created sub-folders “inherit” the key characteristics of the “parent” folder, i.e., the FT and the DEF. However, the user can then choose a different FT and a different DEF, or modify the inherited FT and or the DEF. Certain “special folders” do not require their own FT or DEF. The “My Recent” folder is a typical example as described below. Whenever an FT is assigned (or reassigned) to a given folder or sub-folder the system performs validation to ensure that the designated FT indeed “adheres” to the given folder, i.e., that all the DFs specified in the designated FT are indeed defined within the DEF assigned to the given folder.

Related Folders

Folders may be related by one being a sub-folder of the other or when entries in one reference entries in the other. However; folders may also be related in that a given action in one folder causes a reaction in the other. This can be best illustrated by the following example: The top folder “My Contacts” may use a DEF which defines a Multi-value Reference DF named “Contact Groups”, while the “My Contact Groups” sub-folder under “My Contacts” uses a DEF which defines a Multi-value Reference DF, named “Group Contacts”. The “My Contacts” folder may contain entries, each describing a different contact with a set of DFs such as “First Name”, “Last Name”, “Email Address”, “Address Line 1”, “Address Line 2”, “City”, Zip Code”, “Company”, etc. The “My Contact Groups” sub-folder may contain a “String” DF, labeled “Group Name” with values of said DF being “My Close Family”, “All My Family Members”, “My Close Friends”, “My Neighborhood Friends”, etc. When adding a value entry to the “Contact Groups” Multi-value Reference DF under an entry in “My Contacts”, the present system automatically adds a corresponding value to the “Group Contacts” Multi-value Reference DF for the corresponding entry under the given “My Contact Groups” sub-folder. Thus, for instance, if the user adds “Close Family” value to the “Contact Groups” for “John Pearson” in the “Contacts” folder, the system will automatically add “John Pearson” to the “Group Contacts” DF in the “Close Family” contact group.

Folders may be related by two Multi-value Reference DFs, or by a Multi-value Reference DF related to a Single-value Reference DF. An example would be the “Orders” folder, using a Multi-value DF named “Order Line Items”, and where entries in “Orders” folder use DFs such as “Order #”, “Short Description”, “Order Date”, etc. In contrast, the related “Order Line Items” sub-folder has a Single-value Reference DF named “Order #”, and additional DFs, such as “Part #”, “Short Description”, “Vendor”, “Unit Cost”, and “Quantity”. The “Order Line Items” Multi-value Reference DF of an entry in “Orders” shows the current value entries, plus another, virtual, entry with an Object Title=“<Create New>”. When the user wishes to add a value entry to the “Order Line Items” Multi-value Reference DF, i.e., add a line-item to the given order, clicking on the “<Create New>” entry opens a new tab, showing a blank DEF (a data entry form with blank DFS), which corresponds to the Related Folder, namely, the “Order Line Items”. The value of the “Order #” Single-value Reference DF within the “Order Line Items” is automatically set by the system to point at the given order, i.e., the corresponding entry under “Orders”, while all other DFs will be blank, allowing the user to enter values as needed. In conclusion, the user will save this new entry, then return to the main (first) tab of Pane 20 (which continues to display the given entry under “Orders”), where the system automatically displays the new value entry for the “Order Line Items” DF (which is a link to the newly created entry in the “Order Line Items” sub-folder), while continuing to display the “<Create New>” virtual entry—still allowing the user to continue and add line items to the given order. The “<Create New>” virtual entry is automatically displayed by the system since the relationship of these two folders indicates a Multi-value to Single-value Reference DF type relation. This way, when selecting a given entry under “Orders”, the user can (i) click-select a specific line item, and/or (ii) to view all the corresponding line items, as per the values of the “Order Line Items” Multi-value Reference DF, using a secondary tab in the Pane 20. In the latter case, the system will display all the line items of the given order using the Pane 20 in accordance with the FT assigned to the “Order Line Items” sub-folder. While viewing the Workspace tree (FIG. 2), with the “Orders” folder selected, the first tab will display all the entries under “Orders” using the Pane 20. Within said tab, the user can then click-select a given order and a new tab will be opened across the top, showing the selected order using the “Orders” assigned DEF. The user may then select to view (i) one or more line items; each displayed in its own tab, and/or (ii) choose to display all the corresponding line items, using another tab. Further; on this display, the user may choose to edit an order or line items and save the changes (while each is displayed in its own tab). Moreover, the user can sort the line items by “short Description”, “Part #”, “Vendor”, etc. and see, for example, repeat orders, comparing prices, delivery times, and overall score based on various vendors.

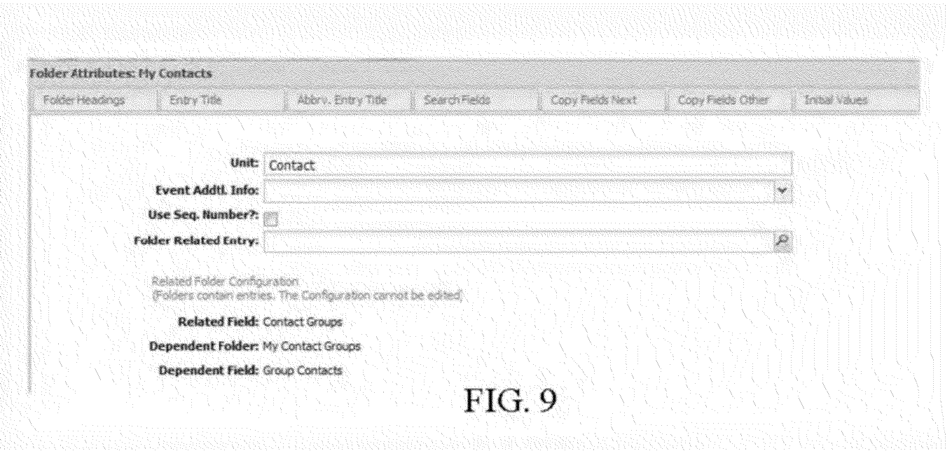

FIG. 9 illustrates the FT definition used to configure Related Folders using two Multi-value Reference DFs. First, the user sets the Dependent Folder (“Related Folder”) and Dependent Field (“Related DF”) of the “My Contacts” folder to “My Contact Groups” and “Group Contacts”, respectively. The system will then automatically set the “Related Folder” attribute of the “My Contact Groups” sub-folder to be “My Contacts”. Then the user sets the Related Field (“Related DF”) attribute of the “My Contact Groups” sub-folder to “Contact Groups”, i.e., stating that the related DF under “My Contacts” is the “Contact Groups” Multi-value Reference DF. The latter part of the process is augmented as follows: (a) the system displays to the user the list of Multi-value Reference DFs as defined by the FT assigned to the “My Contacts” folder, and (b) highlights the DF if there is indeed only one Multi-value Reference DF defined as per the FT of the “My Contacts”. When the user clicks on the Folder Related Entry when selecting Contact Groups membership for a given Contact, a Browsing Tree-View (BTV) is deployed to augment selection of a given Contact Group from all possible Contact Groups memberships for a given Contact. So if the user is editing a given Contact, wanting to add membership in a new Contact Group, the tree view will only show entries under the “My Contact Groups”. Once done, the user can easily view all tile Contact Groups where a given Contact has membership.

The process is similar for Related Folders using Multi- and a Single-value Reference DFs.

Folders may also be related to each other in another way, by automatic association, which is accomplished by using the FT definition of the “Folder Related Entry Folder” attribute. This can best explained by using the following example: the “Folder Related Entry” attribute of a folder named “Michelle's Stuff” may be set to point the “Michelle” entry in the “Contacts” folder. To further illustrate this example (i) the folder called “Michelle's Stuff” may contain disparate documents pertaining to Michelle, e.g., copy of her birth certificate, driver's license, commendation letters, etc., while (ii) Michelle's entry in “Contacts” contains all her demographic information, e.g., First Name, Last Name, Address, Phone Number, etc. By automatic association, all the entries in the “Michelle's Folder” are automatically related with the “Michelle” entry in the “Contacts” folder by the present system. This way, when the user views the “Michelle” entry in the “Contacts” folder he/she is able to also fetch and view any other related entries that Michelle may have in the given Workspace, in this example, all the corresponding entries in the “Michelle's Stuff” folder—without a priori knowing that there are such entries (records) there.

For yet another example on the use and significance of the “Folder Related Entry”, we assume that Eric Barton is a member of the Barton family, and Eric's insurance application is placed in the “Insurances” sub-folder. In prior art folder structures if a user were to view the “Eric” sub-folder under the “Our Household” top-folder, they would not see said insurance application. This is one of the salient shortcomings of the prior art. However, the present system provides an explicit search capability for all “Eric related entries” no matter which folder and/or sub-folder the entries reside in.

Viewing of related entries. This functionality is enabled by using the given structure of the Reference DF (Single-value or Multi-value). As previously described, entries in the Workspace can reference other entries in the Workspace. Thus, for example, certain entries in the “Phone Calls” folder may have the “Participants” Multi-value Reference DF reference “William Smith”, which is an entry in the “Contacts” folder, and similarly, there may be several emails (entries in the “Email” folder”) where the “Sender” is “William Smith”. The present invention provides means for “Viewing Related Entries”. In this particular example, when the user is viewing the “William Smith” entry in the “Contacts” folder, s/he can invoke the “View Related Entries” function to see all the entries in the Workspace where “William Smith” is mentioned, i.e., all other entries in the Workspace where “William Smith” is referenced through any Reference DF in said entries. It therefore becomes possible to have the system automatically search the entire Workspace for all related entries and ensure that all related entries are indeed found.

According to the present invention, it is also possible to move values from one “Reference” DF to another “Reference” DF, for example, moving values from an “Invitees” DF to a “Confirmed Participants” Multi-value Reference DF (as individual confirmations are received in response to an invitation).

My Workspace—Special Folders

Certain folders/sub-folders behave differently from all “regular” folders and sub-folders. These are described as follows:

My Email

Entries in this area are created by (a) uploading email from the user's other email system(s), such as Yahoo, Outlook and Gmail, and (b) by creating and receiving new email directly through the system. The typical DFs used in conjunction with the “My Email” folder and sub-folders are standard “Sender (From)”, “To”, “Cc”, “Subject”, “Body”, “Attachment”, and “Follow-up Flag”. The “My Email” folder and sub-folders are also subject to “Folder Templates (FTs)”. Thus, consistent with all other areas, the “My Email” folder and sub-folders will be displayed using the Tabular-view with column headings following the assigned FT and following the specification of the assigned DEF. The “Sender”, “To”, “Cc”, and “Bcc” DF's used in folders and sub-folders under “My Email” are “Multi-value Reference” type DFs referencing existing entries under “My Contacts”. This again ensures that when searches are performed for given contact related entries all related entries under “My Email”, “My Tasks”, “My Calls”, “My Notes”, etc. are in the search results.

When email messages are received, they contain information about the “Sender”, “To” and “CC”. The system automatically checks to see whether these email addresses are already defined by existing contacts, and where a matching contact is found the system will automatically set the Object Reference of the given DF, i.e., the “Sender”. “To”, or “CC”, to point at the corresponding entry under “My Contacts”. The Object Title of these DFs are handled differently as the system will not display the corresponding Entry Title, but rather the DF name of the matching email address, e.g., “Work Email” followed by the corresponding actual email address. Example: “Work Email: John Doe john.doe@abccoip.com”.

When email messages are received and when the system automatically checks but does not find matching entries based on “Email Address” type DFs, but instead, finds matching entries based on “First Name” and “Last name”, the system proposes to the user to select this matching contact; and suggests the option of updating the given contact by either replacing the existing email address of that contact, or by adding the given email address as a new email address, e.g., “Work Email” or any other email address, including the ability to add a new Email Address on-the-fly.

When email addresses specified in inbound messages cannot be matched with any existing contact, the system will propose to create a new contact. The system attempts to automatically parse the given email address and propose “first name”, “last name” and/or “company name”, based on the email address “display name” and the actual email address. The user may accept these proposed values or override them. The system sets the Object Reference of the corresponding DF, i.e., the “Sender”, “To”, or “CC” of the given email, to point at the newly created entry, and displays the Object Title, as described above.

For unresolved “Sender”, “To”, and “CC” values; i.e., where no matching contacts where found and the user declines to create a new contact, the Object Title of such DFs are set with the given email address and the Object Reference are set to NULL—thus indicating that said value has not yet been resolved.

When composing an email message, and as the user types in the designated email address, the system automatically searches for matching entries under “My Contacts” or any other DF included in the Search Fields defined for the “My Contacts” folders and the sub-folders (e.g., company name, if the “Company” DF is included in the Search Fields). The system also searches by the name entered, as a possible contact name, e.g., “Susan Powers”. As soon as the user has entered a few characters, the system displays matching contacts, if any.

In addition to the searches that the system performs to find matching entries under “My Contacts” (as described above), the system will also search for matching entries under the “My Contact Groups” sub-folder. For example, the user may start typing “My” in the “To” DF, and the system will display matching entries, such as “My Close Family”, “My Neighborhood”, etc. (highlighting the matching characters). When a specific group of contacts is selected within “Group Contacts” this will result in multiple recipients for the given “To”, CC”, or “Bcc” DF, corresponding to all entries in the selected contact group. In another example, if the user types “Joh” the system displays possible matching entries based on the Search Fields of the “My Contacts” folder, which DFs are the “First Name” “Last Name”, and “Company Name”, with matching results shown as follows:
“Work Email: john.doe@abccorp.com”—John Doe, ABC Corp.
“Personal Email: john966@gmail.corn”—John Doe, ABC Corp.

All matching contacts and contact groups are listed—the system displays unique results only. If no match is found, the system will accept valid email addresses as recipients, and will prompt the user, after the email was sent, to create corresponding new contacts, or add said email addresses to existing contacts.

My Contacts

This folder contains the user's contacts using a DEF and a FT, similar to all other folders and sub-folders in the Workspace. However, according to the preferred embodiment, entries in this folder are limited to one sub-folder, named “My Contact Groups”. The “My Contacts” top-folder contains entries each describing a single contact, using a DEF with DFs, such as “First Name”, “Last Name”, “Address Line 1”, . . . “City”, “State”, “Phone Number”, etc.

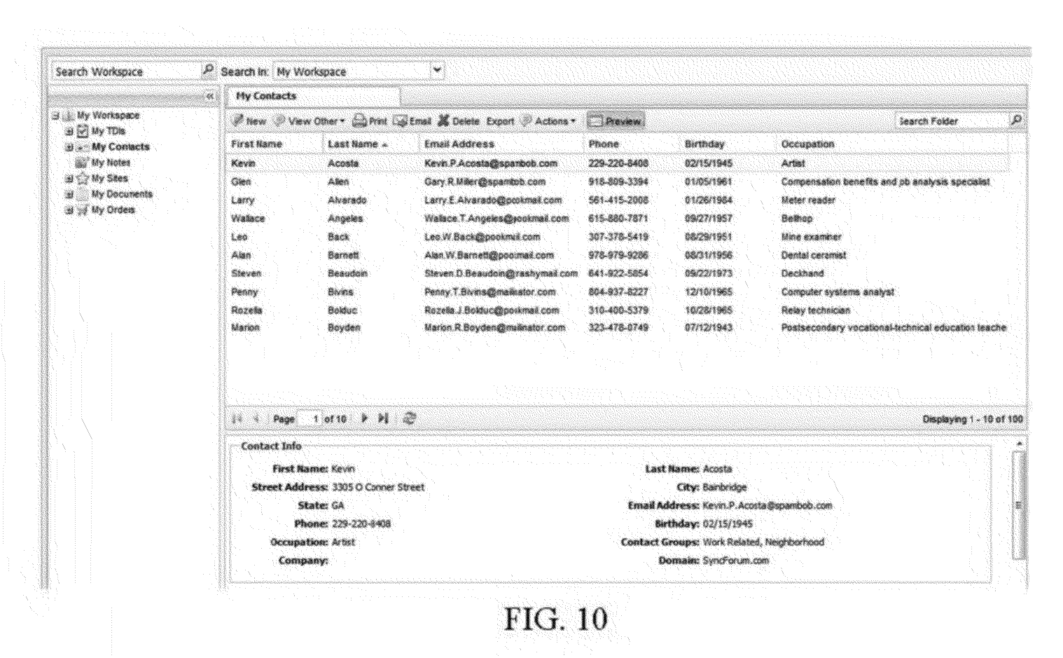

FIG. 10 is a screen capture of an example of the “My Contacts” top-folder. Note that the first row in the Tabular View 20 shows “Kevin Acosta” as the selected entry in this folder. Consequently, the Preview Pane 30 below shows the text version summary of the data pertaining to “Kevin Acosta”. The system provides a sub-folder under “My Contacts”, named “My Contact Groups”, where each entry within contains a group of contacts. This is facilitated by using a DEF, which specifies an Email Multi-value Reference type DF labeled “Group Contacts”, where each value entry of said DF points at an individual entry in the “My Contacts” folder, and furthermore, pointing to a specific Email Address in said entry. Thus, using this Multi-value DF, each entry of the “Contact Groups” sub-folder describes a group of contacts by reference.

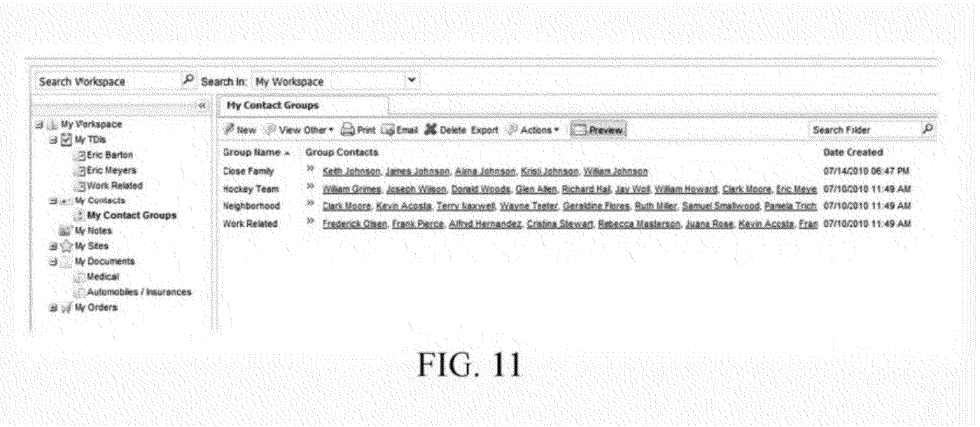

FIG. 11 is a screen capture of the “My Contact Groups” sub-folder shown using the Tabular-view 20, where each row represents an individual “Contact Group”. The FT of this Tabular-view consists of two columns (i) using the “Group Name” DF for the first, and (ii) the “Group Contacts” for the second. Again, the “Group Contacts” is a Multi-value Reference DF, and the display shows the individual value-entries of said DF. Further, the “>>” symbol displayed in front of each list of values, can be clicked and a corresponding “pop-up” window will display all the Contacts for the selected Contact Group. The entry-values of the “Group Contacts” Multi-value Reference DF are shown as hyperlinks and the user can click on each such hyperlink, and the system will display the corresponding entry detail in an adjacent tab, using the DEF assigned to the “My Contacts” folder. The user may also import contacts and contact groups from other service providers or applications.

“My Recent”

This folder is used to automatically capture the most recent entries in the Workspace that the user has either viewed, created, or modified. Entries in this folder are links that “point” at corresponding entries in other folders in the Workspace. Examples: entries in “My Recent” may point to corresponding entries in “My Email”, “My TDIs”, “My Phone Calls”, etc. The order by which these entries are listed by date/time of access using the descending order. The user can click on any entry listed in the “My Recent” folder and the system will automatically (i) select the corresponding folder or sub-folder on the tree-view of the workspace—highlighting the node on that tree corresponding to the folder or sub-folder where said entry resides, and (ii) opening the given entry to be displayed in “Modify View” in its own tab, using the DEF, which is assigned to the given folder or sub-folder. Using this access mechanism, users of the system are able to resume work on entries (records) where they worked recently without the need to search for same or having to use other means for “bookmarking” same.

“My TDIs” a.k.a “My Tasks”

“To-do Items” (TDIs) are items to be tracked, and a collection of TDIs is a “To-do list”. TDIs are used as placeholders of tasks and actions that need to be completed, as well as keeping track for historical purposes. Sub-folders within “My TDIs” may contain TDIs organized by subject, such as “Household”, “Work Related”, “Home Owner Association”, etc.

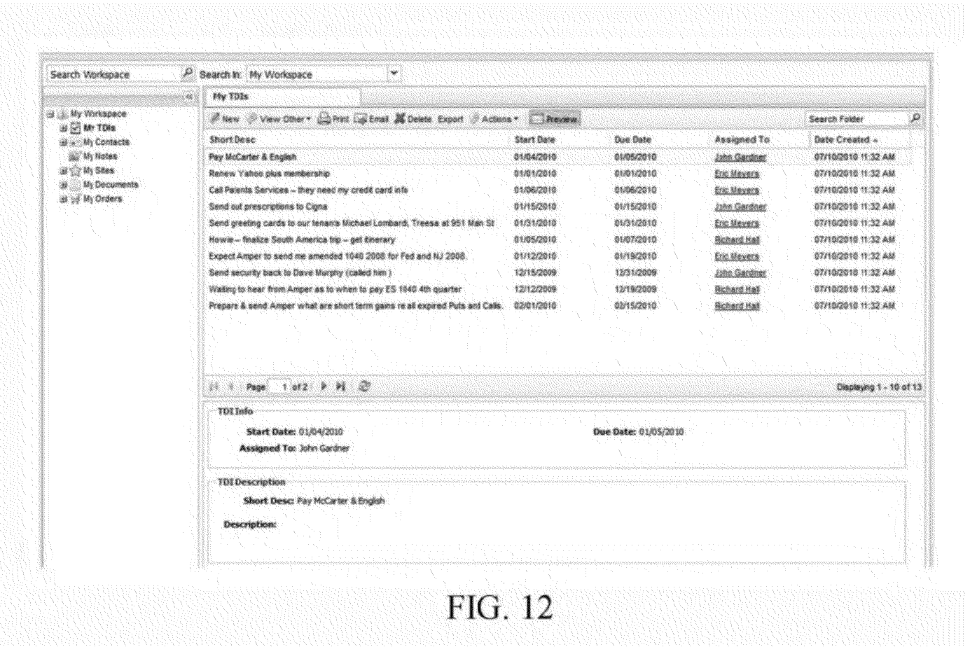

FIG. 12 is a screen capture of the “My TDIs” top-folder shown in the Tabular-view. Each row in this display is an entry in this folder, i.e., a TDI. The FT shown in this example of the TDI folder consists of the following DFs (i) “Short Description”, (ii) “Start Date”, (iii) “Due Date”, (iv) “Assigned To”, and (v) “Date Created”. Each sub-folder in the “My TDIs” folder may be associated with a given “TDI Reason”, which specifies the DEF and the “group status” (see below) to be used for all TDIs in each sub-folder. The “Reason” is a key characteristic of a TDI. It is the type (category) of the TDI. e.g., “Order”, “General Action”, “Pay Bill”, “Research”, etc. More than one sub-folder can be assigned the same “TDI Reason”. The system provides a set of “TDI Reasons” and the user can add “TDI Reasons” as needed. The “Reason” defines three key TDI characteristics: (i) the DEF to use when creating, viewing or modifying a TDI, (ii) which Group of Statuses (GS) to use when “advancing” the “Status” of the TDI (GS actually defines the “workflow” of a certain type TDI), and (iii), which FT to use and to automatically assign when new TDI sub-folders are created. “Status” is a TDI-specific DF, which is used to denote the then current status of any given TDI (task)—it is a progress indicator for TDIs. Examples: “Initiated”, “Open”, “Closed—Done”, and “Closed—Canceled”—while the system provides a set of default statuses “out of the box”, the user can modify same and also define additional statuses to specifically fit his/her needs. There is also the need to define “Groups of Statuses (GSs)”. Each GS is assigned a unique name and contains multiple Statuses, for example, a “Pay Bill” GS may include Statuses such as “Initiated”, “Closed—Done”; while an “Order” GS may include Statuses, such as “Initiated”, “Order Confirmed”, “Partially Completed”, and “Closed—Done”. While the system will allow users to rename individual “Reasons” and “Statuses” it will also validate that values in each such group remain unique within the corresponding group. The user can configure which Status will automatically be assigned to newly created tasks. The user can also specify which Statuses are considered “Closed” and which are considered “Completed”. A “Completed Status is considered “Closed” but not every “Closed” Status is considered “Completed, e.g. the Status “Done” may be defined as a “Completed” status, while “Closed—Canceled” may be defined as a “Closed” status but not a “completed” Status. When working on a TDI, the user can change the “Status” field of the TDI as needed.

The attributes of a Task folder as described above can also be applied to any other folder or sub-folder in the Workspace. The benefits of using a folder as a “Task” folder is the intrinsic ability to apply a “Status” to each entry in such a folder; the ability to post “Activities”; and the ability to view only entries that are in a non-close Status.

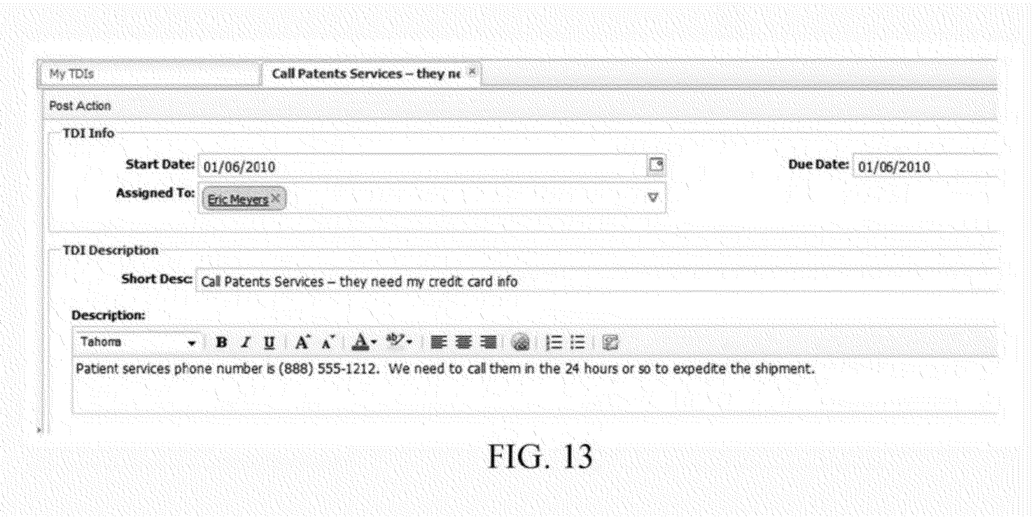

FIG. 13 is a screen capture of an exemplary TDI. The user can create TDIs when working in any other Workspace area, such as “My Email”, “My Documents”, “My Notes”, etc. so long as the “Create TDI” menu item has been included in the “Further Actions” in the right-click drop down menu. When a Task is created off a given entry in the Workspace (the “Initiating Entry”) the TDI maintains a “Link-Back” to point at the Initiating Entry. This “linkage” can be quite useful, as it maintains the desired relationship among such items. This mechanism may also be used to facilitate automatic copying of certain data from the Initiating Entry to the newly created TDI.

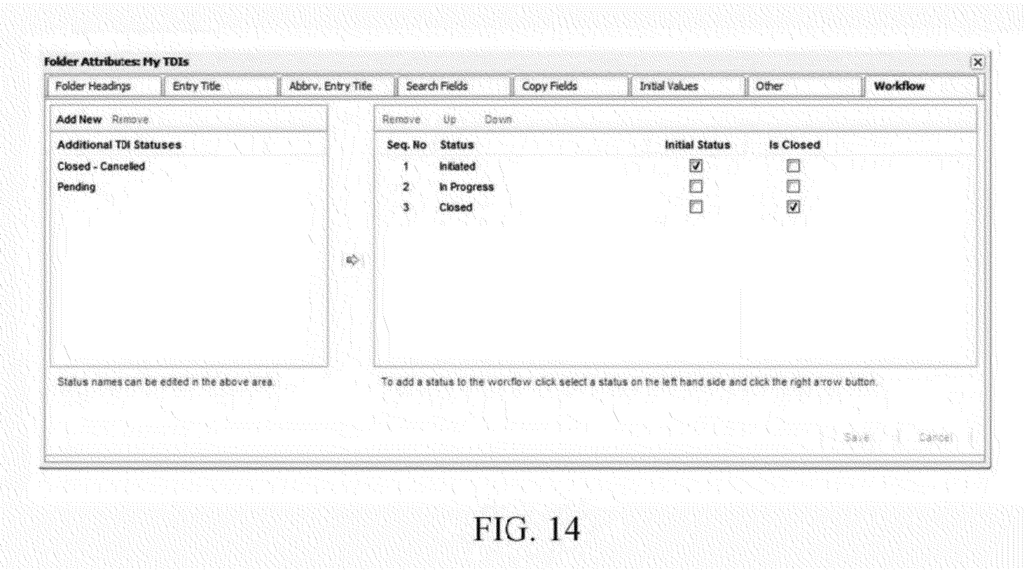

FIG. 14 is a screen capture of the Action Taken form, which makes it possible to post a TDI Action (a/k/a “Activity”), having the following set of DFs: (i) “Action Taken” (a Selection DF); (ii) “Action Result” (a Selection DF); (iii) “Description” (Memo DF); (iv) “Date Action Taken” (Date/Time); and (v) “Next Status (a Selection DF)”. When the “TDI Action” window is displayed, the user enters the necessary data and saves this “Action Taken”.

For each TDI, the system allows the user to see all “Actions Taken”, i.e., “Activity History”, such as “Phone Calls” etc. This “History” display is initially sorted by the “Date Action Taken” using the descending order, and the user is able to change this sorting using any of the displayed fields in this table, as well as change the sorting order.

From a given TDI, the user can link to one or more other TDIs. This is done via DFs type “Reference Field”, which has a related selection DF to indicate whether the referenced TDI should be considered a “Child” or a “Parent”. This information is used when displaying related TDIs in a tree-like format. An example would be using a DF named “Follow-up To-Do”. In which ease, a link stored in this DF “points” at another “follow up” TDI. For example, once a TDI for monitoring an expected inbound wire transfer has been completed, the “follow up” TDI is initiated to ensure that the funds are properly re-invested. Thus, two distinct TDIs are related.

Similar to the foregoing, whenever any entry is created off a Parent Entry, it is designated a Subsequent Entry. Subsequent Entries is a system DF type Multi-value Reference type DF. In the Tabular-view, the system will determine whether to display the “Subsequent Entries” as a heading. The given Subsequent Entries are displayed sorted by the order of creation. The user can drop-down and see the individual values of this field, i.e., the corresponding ET of each said Subsequent Entries, and click-select a given Subsequent Entry to view its detail. A Tabular-view Right-click Menu (TVRM) also provides a “View Subsequent Entries” selection.

Related Entries

As described above the Reference DFT can be a “Single-value Reference” or a “Multi-value Reference”, and each entry (value) of this DFT can be (i) pointing at another existing entry in the user's Workspace, e.g., TDIs, Documents, Email, Contacts and Sites; (ii) a URL pointing to anywhere in the Worldwide Web, and (iii) a link pointing to an independent object, such as an image, a video clip, or a document, which has been uploaded and stored in the system database. Thus, for example, a folder named “My Tenants” may be using a Reference Type DFT, which includes a DF named “Tenant”, which points to an entry under “My Contacts”. It is possible from the tabular view toolbar or TVRM to “View Related Entries”.

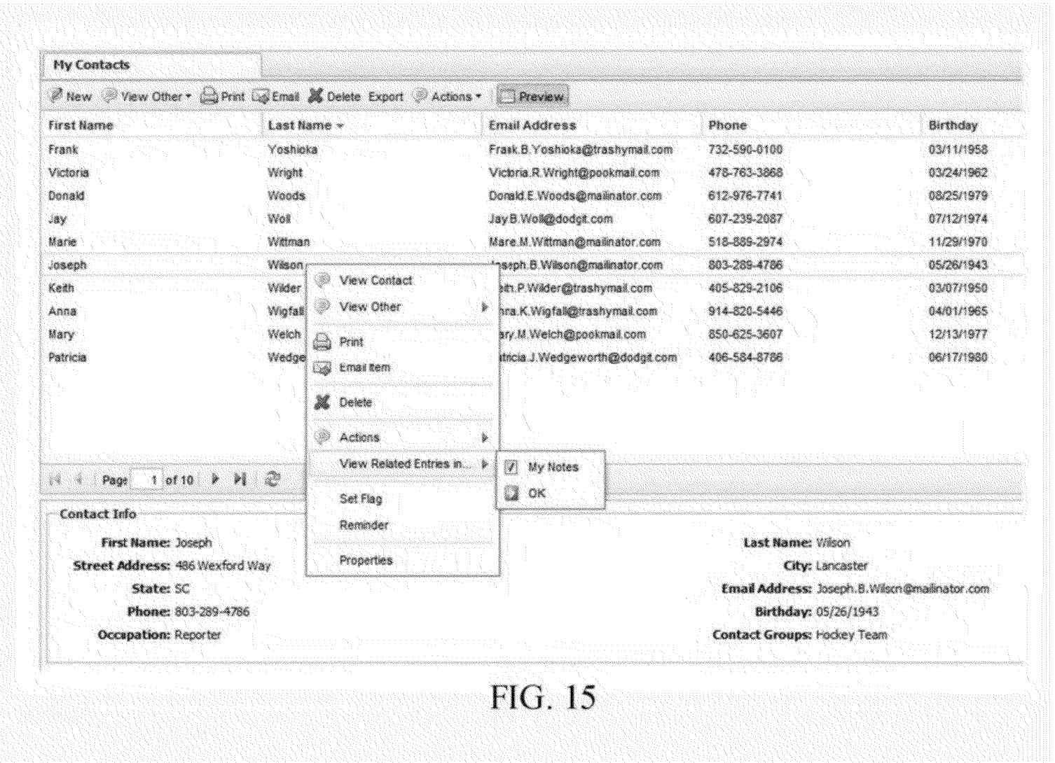

FIG. 15 illustrates how the View Related Entries feature is accessed from the right-click menu. When the user invokes the display of Related Entries for a given entry, the system will display all folders and sub-folders where there are Related Entries referencing the selected entry.

Workspace Searches

Instant Searches are used to perform quick searches to find matching entries in the Workspace. Instant Searches, a.k.a “Quick Searches” are simple search patterns using a single field and using “full text searches” throughout the Workspace, or as it will be explained in the following, searches restricted to a give are within the Workspace. While in the Tree-view 10 (FIG. 2, 3), the user can specify the scope of such searches by selecting either the entire Workspace, or any given top-folder and sub-folders. This is facilitated by allowing the user to browse his/her Workspace and to select any desired top-folder with sub-folders thereunder simply by selecting a given node on the Workspace tree, and setting the “Search In:” DF accordingly.

In contrast to instant searches, the My Dashboard section in the “My Workspace” allows creation of compound queries. The My Dashboard section is accessible from the main Workspace screen by the “Dashboard” button (top center). Each “Dashboard” is a compound query form defining a compound Search Criteria and a scope for said search. Furthermore, the system allows the user to specify an action to be taken based on executed Dashboards. Each Dashboard comprises of the following parameters: Name: assigned by the user, Scope: specific top-folder or sub-folder, and the Search Criteria: given DFs and the specific conditions to be matched for each. Creating a new dashboard is accomplished using the right-click menu when displaying either the “My Dashboards” top folder or any sub-folder underneath. When the user opens to view the contents of the “My Dashboards” top folder, or any sub-folder beneath; the system will display the entries in the selected folder/sub-folder using the tabular-view. Each dashboard is displayed in the tabular view pursuant to a “hard-coded” FT and consist of name, folder, include sub folders {true/false), date created, date executed last, and count (run count). When the user clicks on the “View Results” button or “View Results” Tabular-view right-click menu (TBVRM), the results of the given Dashboard are displayed using the Tabular-view whereby the results of each folder and sub-folder are displayed using separate tabs, one tab per results of found in a given folder or sub-folder. In the preferred embodiment, the Dashboard is called IQ Searches with the exact functional specifications as described hereabove.

Dashboards may also define Triggers, which are predetermined conditions, which when met, may result in certain action every time an IQ Search (Dashboard) is executed. Such actions may be sending an email message, SMS, popping up a message, etc. A Trigger “fires off” based on user predetermined conditions applied to a given IQ Search (Dashboard). The “Triggers” menu item or tool-bar button results in displaying the currently defined Triggers for a selected Dashboard. When a given Trigger is selected, the Preview Pane displays the following information:
Date Created—the date/time the Trigger was created
Name—the name that the user assigned to the given Trigger.
Condition 1—the first condition.
Condition 2—the second condition, if any.
Method—the method to be used when action takes place, e.g., “Email Notification”, “SMS”, etc.
Minutes to Reconsider—the date/time that action was taken last date time action—the Date/time that action was taken last.
Count—the count of matching entries when action was taken last
Method Used—the method action taken last.

Using the right-click menu, the “New Trigger” function opens a new tab, showing the DEF for creating and handling the various parameters (attributes) of a Dashboard trigger. There is another area in the user's workspace that contains all the information pertaining to Triggers that were “fired off”, i.e., that action was taken for. This is the My Triggered Events (MTE) section, and whenever a Trigger is said to have “fired off” the system will create a corresponding entry in the MTE area. All the entries in this area are viewable using the tabular-view. The user can also view the entries that matched the given Dashboard Search Criteria (which caused the Trigger to be activated).

My Reminders

The “My Workspace” also includes a My Reminders folder containing information on each Reminder that was issued. Reminders are issued using Email, SMS, etc. The “My Reminders” Workspace area allows the user to view Reminders, pertinent information, and to acknowledge Reminders as “done”—which will stop the system from continuing to issue Repeat Reminders. When the user opens to view the contents of the “My Reminders” folder, it is displayed using the tabular-view. The column headings are “hard-coded” by the system as follows:
Date Time Issued—the date/time that the given Reminder was issued.
Entry title—the Entry Title (ET) of the WS entry for which the given Reminder was issued. The ET will be shown as a hyperlink, so that when clicked, the system will display the given ET in an adjacent tab using the Modify View.
DF (name)—if the given Reminder was set-up specifying the DF id parameter as the DF for which the value is designated as the time of action, this column will display the name of the given DF.
Is Anniversary—“checked” or “unchecked”—indicated whether the given Reminder is an “anniversary” type reminder.
Method code issued—the method used when the given Reminder was issued, e.g., “Email”, “SMS”, etc.
Date Time Reminder Next—indicating the date time that a Repeat Reminder is scheduled for. This column will be “null” in case that (i) minutes repeat of the given Reminder was defined as “null”, or that (ii) the user has acknowledged the given Reminder, setting it as “done”.
date time read—the date/time that the user has acknowledged and marked the given Reminder as “read”.

The right-click menu provides several options, which are unique to My Reminders, including “View Corresponding” (views the entry for which the given Reminder was issued); “Mark as Read”; “View All”; and “Purge Read Reminders”.

Notifications

The present system allows Notifications to be sent as email messages sent to the user's selected email address. Notifications can also be specified to be sent to mobile phones as SMS messages. Notifications can be triggered by a triggered event, TDI, etc. Thus, for instance, the user may be notified that there are “TDIs Scheduled for Today”, “TDIs Past Due”, “Bills to Pay”, “Drafts of Documents with Inactivity”, etc. When initiating a notification from within a TDI, the system will enable the user to specify a given “Reference” DF to be used for automatically distributing the given notification to all the contacts pointed to by such “Reference” DF. For instance, in a TDI with “Reason=Meeting”, such a “Reference” DF would be “Participants”

Imports—Exports

The system provides a mechanism for exporting and importing data, whereby entries of any give folder/sub-folder can be exported, as well as allowing data to be imported to any desired folder/sub-folder. The system supports a variety of formats, including .CSV and .XML. In the case of importing .XML files, the system will use the XML embedded information to create/define the corresponding DFs, DEFs, and automatically create corresponding folders/sub-folders and FTs.

Browsing Tree-View Modal Window

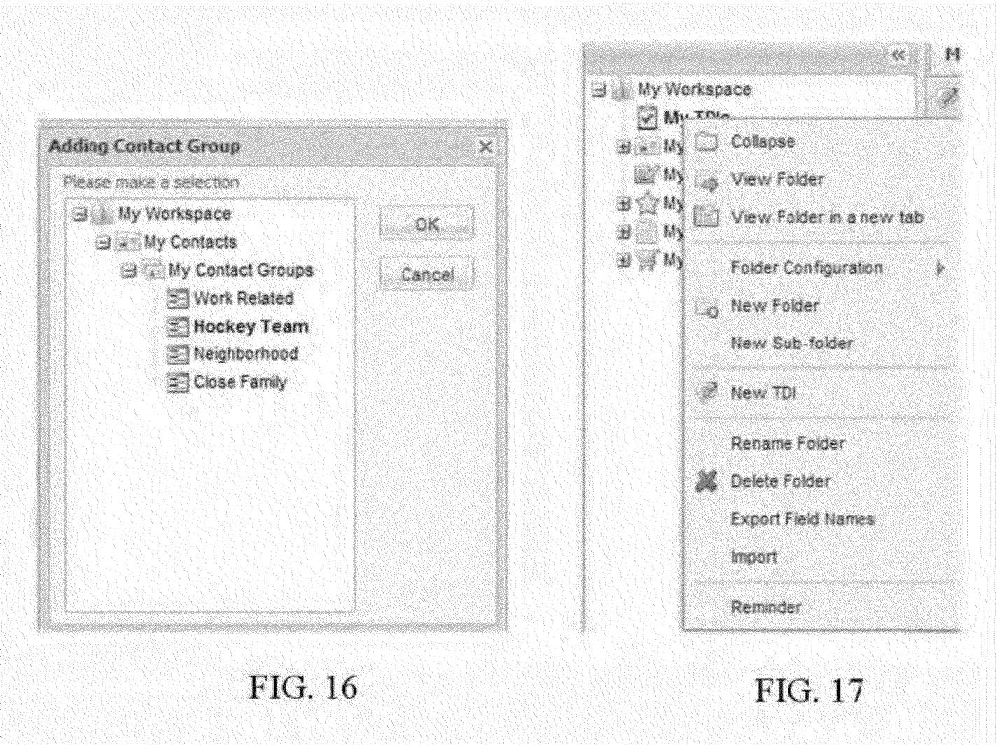

FIG. 16 is a screen capture of the Browser Tree View (BTV) which is an extremely effective tool for menu selection. The “Browsing Tree-view Modal Window” is a pop-up selection tool which will display the Workspace tree or a portion thereof, allowing the user to make the desired selection.

Tree-Top Right-Click Menu (TTRM)

When viewing the ‘Workspace tree (FIG. 2), the user may right-click on the first node, the “My Workspace” node, resulting in a pop-up right-click menu, with the following functions: “Expand/Collapse; “New Folder”. When the user right-clicks on any node, other than the first, it will result in the following additional choices: “View Folder/Sub-folder”; “View Folder/Sub-folder” in new tab; “Folder Related Entries”; “Folder/Sub-folder Configuration”; “New folder”; “New sub-folder”; “New <Unit>”; “Rename”; “Delete”; “Reminder”.

FIG. 17 is a screen capture of the right-click menu.

Workspace Tabular-View Pane 20 Tabs

Referring back to FIG. 3, tabs across the top of the display are created (Automobiles/Insurances) and the space beneath, associated with each, is used to display the corresponding information. From the Tree view right-click menu invoking the selected “View Folder/sub-folder” or “View Folder/sub-folder in New Tab” function will display the contents of the corresponding folder/sub-folder using the tabular-view of all corresponding entries. The same is accomplished when the user left-clicks, selects, a given top-folder or sub-folder. There is also a “View . . . in New Tab” function by which a new tab will be automatically created and positioned right after the last currently displayed tab. This tab will be used for displaying the selected folder/sub-folder.

Examples: (i) the first tab is used to display all the entries of a given folder or sub-folder in a tabular view; a new tab is created (ii) to view a selected entry, e.g., email, contact, document, etc.; (iii) to display order line items from a selected order: (iv) to show related items; or (v) to display the “TDI History” from a selected TDI, etc. When a tab is selected, there are buttons and drop-down menus displayed at the upper portion within the tab, and the area below is used to display the tab specific content, such as tabular view of folder/sub-folder entries, or a selected entry using the form display, based on the corresponding DEF specifications. Each tab has a label assigned to it in real-time which is the DF, as defined by the FT assigned to the said folder/sub-folder. At any time the user may click on the “X” displayed at the right-hand, after the tab label. When clicked, the tab closes, unless the tab content is in a “work in progress” state, such as when the user started to modify a given entry (see below “Modify View”), or in the midst of creating a new one. In this case, the system will prompt the user for whether he/she wants to “Save”, “Proceed” or “Discard Changes” Tabs can be moved or rearranged across the top via drag-and-and-drop operation.

The tab used to display the contents of the given folder/sub-folder will be automatically scrolled into the field of view, and then selected, so it becomes the active tab and is used to display the entries of the said folder. When a folder/sub-folder are initially opened the system will perform one of the following (i) show all entries in a full tabular view, i.e., not showing the Preview Pane 30, or (ii) automatically select the first entry, if any, and display this entry using the Preview Pane 30. This setting is based on the User Preferences applied globally across the Workspace. When a folder or sub-folder is displayed using the tabular view 20, the user is presented with an array of Tabular-View Tool-Bar Buttons above the tabs, plus the user may right-click on any given entry, which will result in a pop-up Tabular View Drop-Down Menu (TVDM).

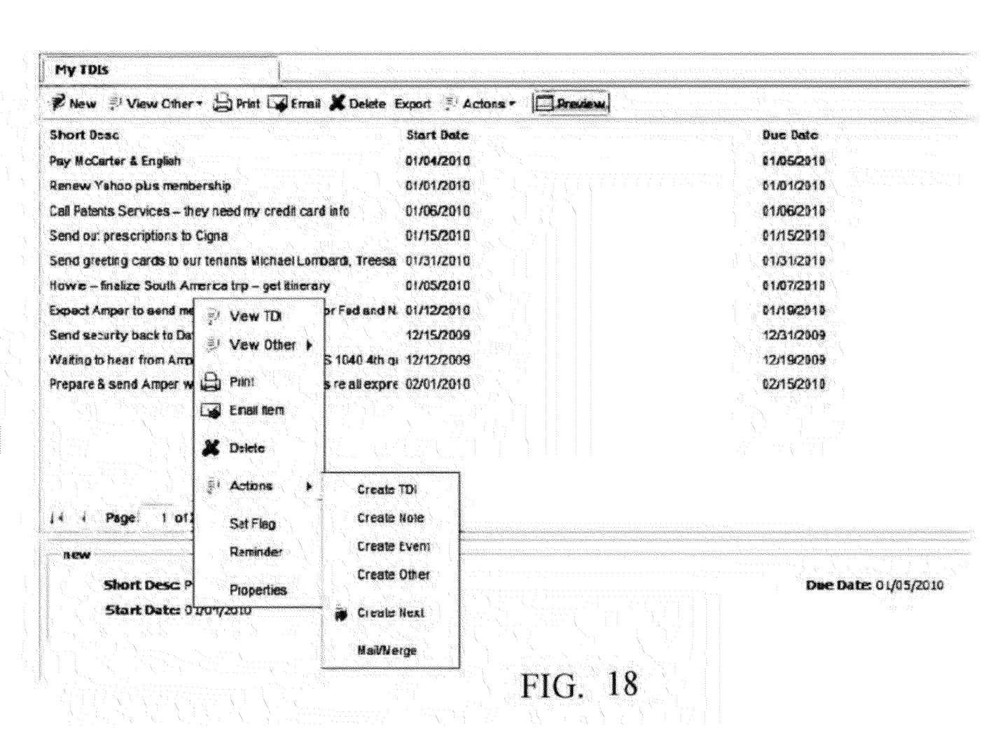

FIG. 18 is a screen capture illustrating both the Tabular-View Tool-Bar Buttons above the tabs, plus the Tabular View Right-Click Menu (TVRM).

The Tabular-View Tool-Bar Buttons above the tabs are as follows:
“New <Unit>”
“View Other:”
   “View <Related>” (if the currently viewed folder/sub-folder has a Related Folder/Sub-folder)
   “View TDI Actions” (if the currently selected entry is an entry in “My TDIs”)
   “View Sequence” (if the currently selected entry is part of a sequence)
   “View <Unit> Related Entries”
   “View Subsequent Entries”
   “View Folder Related Entries” (if the currently displayed folder/sub-folder has the “Folder Related Entry (FRE)” configured.
“Print Item”
“Email Item”
“Delete”
“Export”
“Actions:”
“Create TDI”
“Create Note”
“Create Event”
“Create Other”
“Create Next”
“Mail/Merge”
“Preview/Hide”

The TVRM offers some of the same options, and additionally:
“Set/Clear Flag” (shown if currently the flag for the given entry is not set, otherwise it will be “Clear Flag”)
“Reminder”
“Properties”

Using the TVRM and selecting “Reminder” off a given entry; or Using the Modify View Tool-bar Buttons and menu items, and clicking the “Reminder” button allows the user to set up, view and modify one or more entry-specific Reminders. Each reminder can specify a given Date/Time for said Reminder to be activated or a Date/Date/Time DF, as described above. When the “Reminder” menu item is invoked, the system displays the currently configured Reminders for the given entry using the tabular-view. The Reminder column heading are “hard-coded” and include: name, date/time, DF (name), DF value (if such a DF was specified as the “driver” of a given Reminder), date/time reminder (for advance reminders), anniversary (in which case; reminders are issued each year on the given month and the given day in the month), minutes/repeat (time interval in minutes for Repeat Reminders).

When a, Reminder in the TVRM of Reminders is selected, the Preview Pane will display all the information of the selected Reminder outlined above. The user may right-click on any given Reminder which will result in a pop-up menu allowing the following actions: “New Reminder”, View Reminder“, and “Delete”.

The “New Reminder” allows creation of a new entry-specific Reminder via drop-down list, which contains all Date and Date/Time DFs defined as per the DEF used for the given folder/sub-folder (where the selected entry is contained).

The “View Reminder” displays the given Reminder in Modify Mode. When the Reminder was not yet issued, the user can use the given DEF to modify the given Reminder parameters.

The Properties selection provides for viewing the properties of a folder/sub-folder entry, including:
Initiating Entry—the ET of the Initiating Entry (if any). For example; a given Email that initiated a TDI.
Date Created—date/time the given entry was created.
Created By—the user that created the entry.
Date Updated—date/time the given entry was updated (modified).
Updated By—the user that updated the entry.

Creating a new entry in a folder or sub-folder is accessible through the Tabular-view Tool-bar Buttons and selecting “New <Unit>”, or Using the TVRM and selecting “New <Unit>” off a given entry. When the user selects to create a new entry, the system will automatically create a new tab. The DEF Heading will be set to “Enter all necessary data to create the new <Unit>.” The user will enter all the necessary information and when done, click on the “Save” button. Upon successfully saving this new entry, the system changes the DEF Heading to indicate “New <Unit> was created successfully”; the current tab will then continue to display the newly created entry, using the “Modify View”, as explained hereabove, and the entry will be locked in the database (so that no other user can fetch this entry in “Modify View”). The user may also opt to cancel the creation of the new entry and may do so by clicking the “Cancel” or the tab related “X”.

A user may create a new entry in folder/sub-folder, such as “My Notes”, or “My TDIs”, etc., or create a new entry in a “dependent” sub-folder. For example: the user may create a new entry in a Related Folder where the relationship is using Multi-to-Single-value Reference DFs. A typical example would be: a first tab showing entries in “Orders”, a second tab showing a selected entry of the first, i.e., a selected order, and a third tab showing the line items of the selected order. When clicking on the New <Unit>” button of the third tab, i.e., the tab displaying the Order Line Items tab, that means that the user wants to add an Order Line Item to the selected order.

“Create Next” is a special case of creating a next entry in a sequence of entries in a folder or sub-folder using the TVRM off a given entry and selecting “Create Next”. The system will automatically copy values from the selected entry to the new one; based the “DFs to Copy when Create Next” DFs, as defined for the given DEF. The next entry will be incremented in sequence, and the user concludes by entering into “Modify-View” and completing the remainder. Once the new “Create Next” is successfully completed, i.e., the new entry was saved. The system automatically links the newly created entry to the last entry on the sequence. This facilitates the display of linked entries in a convenient fashion (i) filtering and showing only a given set of linked entries, and (ii) viewing same in the sequence in which they were created (linked), and thus, enabling the user to view a, “sequence of events”, in the order they took place in time: hence the term “Sequence of Entries”. The “Create Next” command is also applicable in the “My TDIs” folder, where the user may want to create “follow-up” type TDIs, and in the “Orders” folder, where the user may select an existing order for given merchandise or a given vendor and create a “linked” next order.

Viewing <Related> entries is accessible using the top Menu or TVRM, and is applicable for entries in a folder or a sub-folder which has a related folder. For example, the user may want to see the related Order Line Items and (ii) when view a Contact Group, the user may want to see the related Group Contacts. In real-time, the expression <Related> is substituted in real-time with the label assigned to the Related DF. Using the above examples (i) the DF in the “Orders”, which is related to the Order Line Items sub-folder, may be labeled “Line Items”, and hence the menu item and the button will display “View Line Items”; and (ii) the DF in the Contact Group, which is related to the “My Contacts” folder, is labeled “Group Contacts”, and hence the menu item and the button will display “View Group Contacts”. When View <Related> is selected, the system will create a new tab, adjacent to the current tab, displaying all the related entries, using the tabular view, e.g., showing all the Order Line Items for a given Order.

The “New <Unit>” button is displayed in the case of Related Folders Using a Multi- and a Single-value Reference DF, such as when displaying Order Line Items, the <Unit> of the “Order Line items” may be defined as “Order Line Item”; and hence, this button will be shown as “New Order Line Item”. When the user selects to create a new Line Item, it will take place in a newly created tab, labeled “New Line Item”.

Viewing TDI Actions entries is applicable only when the given entry is a TDI. When “View TDI Actions” is selected, the system will create a new tab, adjacent to the current tab, displaying all the Actions of the given TDI, setting the DEF Heading to “TDI Actions for: <ET>”, where the <ET> expression will be replaced in real-time with the Entry Title of the given TDI, as per the DEF definition of the given folder or sub-folder.

“VIEW SEQUENCE” is enabled when a given entry is part of a chain of linked entries (as explained above under “Create Next”). Selecting the “View Sequence” item the system will create a new tab, adjacent to the current tab, showing the entry in “Modify View”. Within this newly created tab, the system will display all the chained entries where the given entry is part of, using the tabular view, and highlighting the currently selected entry (showing where it is in this sequence).

“View <Unit>” opens the selected entry in its own tab, using the “Modify View”. A special case is when the user opens an entry, which is already displayed in its own tab, in which case, the system will re-select that specific tab.

“Create Next” invokes the “Create Next” function, as described above.

“Order By” re-orders the Sequence of Entries by one of the Date or Date/Time DFs used by the corresponding DEF (of the given folder sub-folder). Whenever displaying a Sequence of Entries, the display will also show the “Seq. No” column (as the first column). The system allows the user to reposition any entry within the given sequence, and thus, re-arrange entries in the sequence as desired by “Order By”, or the user can drag any entry and drop it after or before any other entry.

Viewing Related Entries is enabled when the given folder/sub-folder has the “Folder Related Entry attribute (described above) populated with a pointer. When “View Related Entries” is selected, the display results in showing folders/sub-folders, where there are related entries. Each folder is displayed in its own tabs, and only shows related entries. The user may right-click on any given entry, which will result in a pop-up menu item “View <Unit>”, the same button being displayed across the top of the tab. This function opens the selected entry in its own tab, using the “Modify View”. “View Related Entries” allows the user to identify all entries that are referencing the given entry.

“View Subsequent” (viewing subsequent entries) is enabled when a, given entry is an Initiating Entry (other entries were created from this given entry). When “View Subsequent” is selected, the display shows the subsequent entries using one or more newly created tabs. A new tab will be created for each subsequent entry in a given folder. Thus, for example, if an entry in “My Email” has two subsequent entries in “My Notes”, and one Subsequent Entry in “My TDIs” then the display of Subsequent Entries, will result in two newly created tab. When invoked, it will open the selected entry in its own tab, using the “Modify View”.

“Print” will print an entry in the format used in the “Text View” for printing the contents of an entry. This will include a heading, which will comprise of the Entry Title, followed by a sequence of {DF label, DF content}.

The “Email Item” function prompts the user for the “To”, “CC”, and Bcc” recipients. The Subject of the email will comprise of the ET of the given entry, and the system will use the format used in the “Text View” as the body of the email message, which will re-iterate the ET, and using “Text View” format, it will have the sequence of {DF label, DF content). Any referenced independent objects will be sent as an attachment, and any other referenced items, i.e., entries within the Workspace, will be included in the body of the email using their corresponding Entry Title concatenated with their folder or sub-folder name (whether the latter is a prefix or suffix). URL references will be included as is, i.e., showing the URL as a hyperlink.

The “Mail/Merge” function prompts the user to select the desired “Mail/Merge” document (template), which usually will be stored under the “My Documents” folder or a sub-folder beneath, e.g., “My Templates” sub-folder under “My Documents”. The system will then perform a “Mail/Merge” using the Mail 1Merge specified DFs and the corresponding values as per the selected (in the given folder/sub-folder).

The “Delete” button deletes selected entries when in any tabular view. The “Delete” operation will be applied to all the selected entries. When the user has confirmed the “Delete” operation, and if within the tabular-view, said view will refresh to re-fetch all non-deleted entries. Any deleted entries are tagged as “deleted items” in the system database, and will be available to be viewed in the “Managing Deleted Items” mode of operation. In this mode the user may decide to restore certain items and permanently delete others.

A TDI can be created off any relevant entry anywhere in the Workspace as described above. The user clicks the Tabular-view Tool-bar Buttons and click on “Create TDI” from the “Further Actions” sub-menu. A new tab will be created in which it will display the DEF corresponding to the given folder/sub-folder. The DEF heading will indicate “Creating a TDI associated with <ET>”, where the <ET> expression will be substituted in real time with the ET of the entry for which a “linked” TDI is to be created.

Similarly, a Note can be created off any relevant entry anywhere in the Workspace using the Tabular-view Tool-bar Buttons and clicking on “Create Note” from the “Further Actions” sub-menu. This attaches a Note to the currently selected entry. When the “Create Note” is invoked and the “My Notes” top-folder has no sub-folders, the selected folder/sub-folder becomes the destination. Otherwise, the user is prompted to select the folder/sub-folder as the destination, where s/he wishes to create the new entry. Thus, a Note can be created off a selected catty in “My Phone Calls”, where the user may wish to document some thoughts, or reaction, which may be the basis of some future action. The Link-Back “Reference” DF of the newly created Note will be automatically populated to point at the Initiating Entry.

Using the TVRM off a given entry and selecting “Create Event”; or Using the Tabular-view Tool-bar Button and clicking on “Create Event” from the “Further Actions” sub-menu, or Using the “View <Unit>” Related Buttons and selecting the “Create Event” menu item from the “Further Actions” drop-down menu will initiate the Creating an Event dialogue. The system will display a modal window in which the My Calendar (MC) will be displayed (described below), and the user will pick the appropriate Date/Time slot on the MC for creating the corresponding Event. Thus, for example, an Event can be created based on a received Email, or off a selected entry in “My Phone Calls” should the user wish to follow up later or schedule a meeting.

“Create Other” is accessible using the TVRM off a given entry and selecting “Create Other”; or using the Tabular-view Tool-bar Buttons and clicking on “Create Other” from the “Further Actions” sub-menu, or using the “View <Unit>” Related Buttons and selecting the “Create Other” menu item from the “Further Actions” drop-down menu. Whereas “Create TDI”, “Create Note” and “Create Event” are specific entries that can be created off another, existing event, “Create Other” is a more generic way of creating an entry in the Workspace off a given entry (the “Initiating Entry”). When this function is invoked, the user can create an entry anywhere and once created; such other entry will be linked back” to the “Initiating Entry.” When the “Create Other” is invoked the user is prompted to select the folder/sub-folder as the destination where s/he wishes to create the new entry. A new tab will be created in which it will display the DEF corresponding to the given folder/sub-folder. The DEF heading will indicate “Creating a <Unit> associated with <ET>”, where <Unit> is that of the destination folder/sub-folder, and the <ET> expression will be substituted in real time with the ET of the entry for which a “linked” TDI is to be created. The user can create the entry using “Modify View”.

My Calendar

“My Calendar (MC) is a significant resource offered by the system. Unlike all entries in the user's workspace, the MC is displayed using typical calendar graphical formats. Dates with entries will have corresponding indicators for weekdays, holidays, as well as for scheduled events. Event entries in MC are shown in the calendar. The user is able to enter scheduled events directly through the MC, and can specify whether such entries should automatically create an entry in the “My TDIs” section. While working with TDIs, the user can specify whether certain DF type Date and Date/Time should be posted as events within the MC. If so, the AET of the corresponding TDI are displayed as a “link” within the given MC entry. The user can open the corresponding TDI by pressing on the given link.

The MC employs “Calendar Layers (CL)”. Each CL will have its unique “Calendar Layer Name (CLN)”, and a designated unique color “Calendar Layer Color (CLC)”. When posting an event on MC, the user are able to choose the “type” of event, which will correspond to a given CL, such as “Family and Social”, “Work Related”, etc. the system will also use the “Default Calendar Layer (DCL)”, where events can be posted without specifying the event type. The system displays a single or multiple overlayed CLs as a single calendar, using a same graphical user interface, and showing events, which are color-coded, based on their “event type”, i.e., the CL they were posted.

Using My Workspace—User Registration

When users visit the site, they will see marketing content. The home page also invites users to either (i) sign in, which will be applicable to users who have already registered, or (ii) join. When registering as new users a registration form is completed with personal information (first name, last name, address, phone numbers, etc.), security questions, a security image, requested login ID, password, and email verification. The ASP will send an email to the user with an embedded URL. Clicking the URL will bring the user to the website to complete the registration process. The ASP will create a new Workspace (WS) for this new user, copying folders and sub-folders from the Master System Workspace (MSW) to the newly created user's WS. These folders and sub-folders will include (i) the “core” MSW, which comprises of folders, such as “My Email”, “My TDIs”, “My Documents”, “My Notes”, and “My Sites” (designated the “Core” of the WS); plus (ii) additional folders and sub-folders, based on the response to the questionnaire. Alternatively, users can review the then currently available set of pre-configured folders and sub-folders, view a high-level description of each of the displayed folders/applications), and make the initial selection themselves. The user can view the content using the regular tabular-view, as well as examine each entry, where each entry provides the necessary information for describing the given application, so that users can decide whether they would be interested in same.

The user can select any of the entries to be included in his/her WS, i.e., selecting any applications, which the user is interested to incorporate in his/her WS.

After creating the new user's WS and populating it with the initial folders and sub-folders, the user is now ready to start to review email, create TDIs, create notes, etc. On future visits the user selects the “Login” option, and upon successful completion of this process, enters the WS. Users may request and be granted access and corresponding permissions to multiple WSs.

Collaboration

The system includes a mechanism for selectively sharing the user's Workspace with other users. A user who is the owner of a Workspace may provide access to one or more users to either (i) the entire Workspace, (ii) certain folders or sub-folders, or (iii) certain entries within a given folder or sub-folder.

Using the preferred embodiment of the present invention a user may request access to another user's WS, which request is received by the Owner of said Workspace, and where said Owner may either grant access or reject the request. Once the Owner grants access, he/she may specify which areas in his/her Workspace said access is granted, as well as the nature of said access, which permissions include, but not limited to combinations of any of the following basic permissions (i) View; (ii) Modify; (iii) Create New Entry; (iv) Delete Existing Entries; (v) Create New Folder/Sub-folder, and (vi) Delete Folder/Sub-folder

The requesting user clicks the “Join another Workspace” button (or hyperlink) in an Administration menu. The system displays a new page, where the given user enters the email address of the owner of the WS his/her wishes to be granted access to. In response, the system generates an Inter-system Notification, which specifies the requesting user ID and sends the notification to the owner of the other WS. When a WS Owner receives an inter-system notification, indicating that another system user is requesting access to his/her WS, the system fetches the information pertaining to the requesting user from the system database based on the requesting user ID. Consequently said notification will display to the Workspace Owner the requesting party information, such as his/her <first Name> <last name> along with the requesting user's Email <requesting user's email>, e.g., said notification will be “Wayne Goddard, having an email address of wayne.goodard@aol.com is requesting access to your Workspace. Please note that if you grant access, it will be limited to specific folders and permissions that you will be granting to Wayne”. Exemplary actions for this Inter-system notification will be (i) “Approve; (ii) “Reject”; and (iii) “Will decide later”. When the WS owner selects the “Approve” option, the system will enter into the “Set Permissions” mode which allows a WS Owner to set manage the permissions of any given Guest User. This will allow the WS Owner to modify permissions already granted; grant access permissions to a new Guest; copy access permissions from a given Guest User to another Guest User; and to remove a Guest User altogether. In the preferred embodiment of the present invention, the “Set Permissions” mode entails a GUI with a drop-down list of all the Guest Users, sorted by alphabetical order with specific navigation buttons, and or hyperlinks.

When the WS Owner selects to “Copy permissions from another Guest User”, the system displays a modal window, showing a drop-down list of all the Guest Users, excluding the currently selected Guest User in the Set Permissions mode. The WS Owner then selects a given Guest User from said list and clicks “OK”. The system will automatically copy all access permissions from said Guest User to the currently selected Guest User under the Set Permissions mode.

When the WS Owner selects Remove Guest User, the user can confirm this operation and remove the given Guest User from the database.

In addition to the foregoing, while in Set Permissions mode, the Tree-view menu of the Owner's Workspace displays menu options, which are specific to this mode of Set Permissions, enabling the setting of permissions on any desired folder/sub-folder, and where said Tree-view menu is invoked by right-clicking on the given node on the WS Tree-view, which node represents either a folder or a sub-folder. Once the WS Owner grants certain permissions for a given folder/sub-folder, said permissions will be displayed on the WS tree-view. The name of the given folder/sub-folder, i.e., the given node on the WS Tree-view having any access permissions will be displayed using a color, which is different than the one used in the usual Tree-view of the WS. Using the preferred embodiment, the permissions granted to a given guest user will be displayed by having each folder/sub-folder with any access permissions to display a pseudo entry at the next level (as a sub-level node of said folder/sub-folder), which pseudo entry will include (show) any of the following possible exemplary permissions:
View: The user can view all entries in the given folder/sub-folder. However, cannot modify, create or delete.
View/Modify: The user can view and modify all entries
View/Modify/Create: The user can view, modify all entries: create new entries, but cannot delete entries other than what his/her has created.
View/Modify/Delete: The user can view, modify and delete any entries; but cannot create new entries.
View/Create: The user can view existing entries, but cannot modify or delete these.
Create: The user can create entries; but cannot view entries other what they have created.
Create Sub-folder: This permission allows a Guest User to create a sub-folder beneath a given folder/sub-folder.

When the WS Owner is done setting the desired permissions on one or more folders or sub-folders in his/her Workspace, his/her clicks the “Save” button saves said permissions for the selected Guest User. After saving access permissions for a new user, the Window Heading will display “Permissions for new Guest User successfully saved”; and after modified permissions for an existing Guest User were saved, this heading will display “Modified permissions successfully saved”.

While working with a currently selected WS the user may want to switch to a different WS. This is facilitated through the “Administration” part of the web application where the user clicks on the “Switch to another Workspace” button (or hyperlink).

In addition to granting access by request of other user's, any user can submit one or more entries from within his/her Workspace (WS) to be viewed by other persons. As a result of submitting one or more entries, recipients will receive an email, and using a hyperlink embedded in same, will be served a page off the website, which page will provide heading information, describing why said page is being served, as well as display the content of the submitted entry (or entries). To initiate the “Submit” process, the user selects an entry, or multiple entries, and then clicks-selects the “Submit” menu item. The user is then prompted to select the desired contacts, i.e., such as entries in his/her “My Contacts” to be published. This will be facilitated by using a dialog window having (i) a title; (ii) a Multi-value Reference DF named “Recipients”, (iii) a “Subject”—String DF, (iv) a “Comments”—Memo DF, (v) an “OK” button, and (vi) a “Cancel” button. By way of example, the title would be “Submitting an entry: <ET>”, in the case a single entry was selected; or “Submitting selected entries”, in the case that more than one entry were selected. The expression <ET> is substituted in real time with the value of the Entry Title of the given entry. By way of example, the default value for the “Subject” DF would be “<User's Name> wishes to submit valuable information”; the user has the ability to override this default subject by entering any other desired text, such as “Great place for pizza”. The expression <User's Name> is substituted in real time with the actual First Name and Last Name of the currently logged in user, e.g., “John Doe”. The user can enter text into the “Comments” DF, e.g., “Best pizza we had in years. Close by. Take a look”. Entering recipients is accomplished with the Automated Search of the “My Contacts” folder. Once submitted, the system sends an email with an appropriate hyperlink to the specified recipients. The body will include a hyperlink plus the “Comments” as described above. When the recipient clicks the hyperlink they are given access to content of the given submitted entry (or entries). The actual display of each entry will be using a display format similar to the one used in the Preview Pane, and using corresponding HTML, so that it can be presented within the browser page.

Users can also export a folder, or a sub-folder from his/her individual WS to a selected one or more users. When exporting a folder or a sub-folder, such export may be specified to include just the selected folder (or sub-folder) configuration, i.e., without contents; or the folder/sub-folder with content (all related DFs, DEF, FT, the folder name, and all the folder attributes are exported). Recipients of such exports will undergo a “Receiving” process, which is using the principal email mechanism described above. Upon accepting, the selected components would be imported into the given recipient's WS. Launching the export process will be facilitated by using a dialog window having (i) title; (ii) a “Subject”—String DF; (iii) a Multi-value Reference DF named “Recipients”; (iv) a “Comments”—Memo DF; (v) “control” check-boxes; (vi) an “OK” button; and (vii) a “Cancel” button. The “control” radio-buttons include: Configuration Only; Folder Only; Configuration and Content; and Folder and Sub-folders

An Export dialog window reminds the user what the export is about. For example, in case that a single entry has been selected for export, the title will be set to indicate “Exporting entry: <ET>”; where <ET> is substituted in real time with the Entry Title (ET) of the selected entry. When more than one entry have been selected for export, the title will be set to “Exporting <n> selected entries”; where <n> is substituted in real time with the actual count of the selected entries. When a folder including its entries have been selected for export, the title will be set to indicate “Exporting folder <folder name>”; where <folder name> is substituted in real time with the name of the given folder. The “Subject” DF is set to “<system User> wishes to export an entry: <ET>”; where <system User> is substituted in real time with the “First Name Last Name” of the user who is initiating the given export, and <ET> is substituted with the Entry Title (ET) of the selected entry. When the user has entered all the necessary information within the Export dialog window, his/her can initiate this “Export” by pressing “OK”, or cancel by pressing “Cancel”.

Conversely, importing a folder/sub-folder means creating the corresponding folder/sub-folder and importing all the related folder/sub-folder configuration, i.e., DFs, DEF, FT, as well as the folder name and all its attributes. When creating a sub-folder as a result of an import, the system automatically creates all needed “parent” folders.

When importing a sub-folder, and copying the attributes as described above, said import may also result in adding DFs to the “pool” of all DFs defined for the corresponding top-folder. Any DFs used by the imported sub-folder will also be added to the library of all DFs defined. The mechanism of exporting/importing folders, sub-folders without their corresponding entries entails copying all the corresponding folders and sub-folders for the selected system applications, creating same in the new user allocated WS.

Configuration Permissions

In addition to normal user permissions, administrative users (Admin Users) have access permissions to Workspaces, which are defined as System Workspaces (“System WSs”). An Admin user can “lock” configuration of any folders and sub-folders within any given System WS. The benefit of this new art is to eliminate accidental change of configuration of folders and sub-folders. “Locking” a folder means that all configuration and related folder attributes cannot be changed, which includes the disability of defining new DFs, renaming existing DF, changing the FT or the DEF, or changing any of the folder attributes.

“Power Users” have certain admin functions, but cannot login and use the Admin Utility. A Power User can login and have access to any System WS; they can create new folders and sub-folders, perform configuration, such as creating new DFs, renaming existing DFs; define and change FTs and DEFs, and define and change folder attributes. They can perform all these functions on any folders and sub-folders which are not locked. Power Users cannot change the “Is Master” attribute of any System WS—only Admin User can perform such settings.

Managing Deleted Items

All deleted items, i.e., folders, sub-folders and entries are marked internally, within the database, as “marked for deletion”. They are no longer displayed in the normal Workspace mode of operation. However, these items have not yet been purged from the database. They are waiting to be marked for final deletion, and upon confirming said marking, will be permanently deleted from the database. The system provides a “Managing Deleted Items” mode with the ability to view items marked for deletion and, then mark items for final deletion or restoration. Entering the mode of “Managing Deleted Items” is facilitated from the “Administration” menu item and clicking the “View Deleted Items” button (or hyperlink). A “Managing Deleted Items” GUI is provided showing only nodes and entries representing items, which are marked for deletion. In this mode the system needs to display folders/sub-folders that either (i) themselves are marked for deletion, (ii) contain sub-folders at any level, which are marked for deletion, or (iii) contain entries that are marked for deletion at any level beneath. Each such folders/sub-folders is displayed on the WS tree-view in this mode; while others will not be displayed. The TVRM is available while in “Managing Deleted Items” mode, but the only menu item available is “View”, which when selected, will result in showing the content of the given folder/sub-folder using the tabular-view, and using the first tab. Similarly, viewing the contents of a node is enabled only when a node has any items marked for deletion. Two (2) columns are added preceding the regular column heading (as per the given FT). The first column having the heading “Delete”, and the second column having the heading “Restore”. The user can check one column or the other. There is no right-click menu in the tabular-view, nor any Preview Pane operation in this mode.

A “Resume IQ ‘Workspace Mode” button (or hyperlink) is always accessible during “Managing Deleted Items”.

The Admin Workspace

The “Admin WS” is a special purpose Workspace which comprises one or more root-folders, each root-folder serving a special purpose. Without limitation, two such root-folders are designated as the “Expert Data” root-folder, and the “Public Area” root-folder (described below). The permissions for the Admin WS are set such that any root-folder can be viewed by any Admin user (or Power user or any other user with permissions) from any user or ASP clients 13 or servers 14 anywhere from within any other Workspace. The Admin WS is designated by an attribute “is admin” which is set upon creation to have a “true” value. Upon login the Admin user can “View Admin WS”, which appends the root-folders residing in the Admin WS into the given WS that she/he is currently logged into. Thus, where an Admin user is currently logged into a Workspace and selects to view exemplary “Public Area” and the “Expert Data” root-folders in The Admin WS:, the displayed Tree Pane 10 will be:

+ Public Area
+ Expert Data
+ My Workspace

The Admin User can expand any of these root-folders, view the content of any top-folders and sub-folders therein; create new folders and sub-folders; and populate each with data entries. This includes the ability to perform searches in root-folders, as well as in any sub-folder therein.

Public Area

The “Public Area” resides in the Admin WS, as described above, and provides a place where Admin users, and other users with permissions, can maintain a set of top-folders and sub-folders that are available for viewing by the overall user population. This includes expanding and collapsing folders and sub-folders, as well as the search and display functionality but general users are not granted permissions to delete folders, sub-folders or entries in this area. The purpose of the Public Area is to offer all users a knowledge base of information. Thus, at the very top level, general users will see two root-folders:

+ Public Area
+ My Workspace

The “Public Area” offers established and compiled data, allowing users to perform structured searches, to view and efficiently sort through the corresponding results. Examples of folders in the Public Area are folders containing information on products, services and knowledge, such as “appliances”, “electronics”, “computers”, etc.; and folders containing entries describing services.

Thus, general users can search the Public Area for products or services, and will be able to make informed decisions and take actions based on such searches, including issuing purchase orders directly and cataloging same using their personal “Orders” folder structure within their own WS. Thus, at the very top level, IQ users will see two root-folders, demonstrated as follows:

```
+ The World (proposed name for the Public Area)
    − Goods
      • Appliances
      • Electronics
      • Furniture
      • Office Equipment
+ My Workspace
```

The structure of the Public folders and sub-folders is identical to the general user WS including DFs, DEFs, and FTs, and related Folder Attributes as described previously. The content of the Public Area will be populated by the ASP or third-party entities given permissions, such as manufacturers, distributers, service providers, associations, colleges and non-profit organizations. Typical entries in Public folders will include Reference DFs, which embed URLs to such third party's corporate web sites. The advent of this feature will augment the WS tree structure described in our Previous Filing. As mentioned above, without limitation, and by way of example, the “Public Area” will be a new root-folder accessible within all IQ users' WS, this top-folder will be designated “The World”. The user can expand the Public Area, i.e., “The World” root-folder, to view all folders and sub-folders within. Thus, using the Ad-hoc query technology described above a user can construct and execute structured queries throughout the Public Area, for instance, to search for colleges, where the geographical area is “Northern Eastern U.S.”, annual tuition is in the range of “$40,000 and $50,000”, and which colleges rank should rank in the “top 50” in their region, as well as selective grouping and sorting of results.

Common Area

Similar in concept to the super-positioning of the Public folders and sub-folders within the user's WS, the “Common Area” offers users the ability to include folders/sub-folders from other WSs (assuming he/she has Guest User permissions) onto their own his/her own WS. Access privileges are also permission-based, but for the Common may include the ability to create folders, sub-folders, and to view folders, sub-folders, and entries within, as well as to modify, create and delete entries. The displayed WS Tree View Pane 10 is as follows:

```
+ Public Area)
+ My Workspace
+ Common Area
      ABC Insurance Company
      Marlboro Soccer Team
```

Only folders/sub-folders where the given user has Guest User permissions are displayed. However, all previously described functionality for such folders/sub-folders is provided. The benefit of this feature is collaboration with other users without having to log in and out from one WS to another. In addition, the system automatically consolidates the “My Contacts” from the various shared WSs into the WS of the user. Specifically, the “My Contacts” under each WS, where the given user is a Guest User will are not shown at all. The user's “My Contacts” top-folder will display his/her own entries, as well as the “My Contact Groups” sub-folder. In addition, all “My Contacts” folders and “My Contact Groups” sub-folders from other user's “My Contacts” folders are appended to the current user's “My Contacts” folder (given proper Guest permissions). The appended folders/sub-folders are renamed “<WS Name>—Contacts”, e.g., “Wyndham Association—Contacts”, and “Wyndham Association—Contact Groups”. This functionality ensures that searches through all entries under “My Contacts”, “My Contact Groups”, as well as all the sub-folders described above, include those of the other WSs.

The system provides a similar consolidation of “My TDIs”, “My Entities”, all using the “Common Area” concept.

Expert Data (Curated Data)

Certain users of the present invention may have one or more area of expertise pertaining to one or more topics or areas of interest. Such users, designated “Experts”, may be interested to share their knowledge and expertise with other users of the system. Examples of useful areas of such expert data would be “Recipes”, “Automobiles”, “Real Estate”, “Household Repairs”, “Travel”, “Financials”, and “Electronics”. To clarify, said expert users may be using the system as for organizing their lives, handling their email, task, documents, notes, etc. However, in addition to their regular use of the system they may have also created folders and sub-folders with entries with valuable data, which they would like to share with other users of the system. Unlike the need to provide explicit access to a Workspace, such as what was previously described for Guest Users, the present invention provides yet another mechanism according to which users can share areas within their Workspace with other users of the system. The system allows users who offer such valuable information means to make their areas within their Workspace accessible to others, on one hand, and for the general population of users of the system to be aware of such expert data being available, on the other hand. This adapts a Wikipedia™ model, albeit in the context of the present system mechanics. As users become aware of Expert data offered by the various Experts, they can decide whether they want to include the corresponding areas, i.e., folders and sub-folders, to be accessible from within their own Workspace. The system maintains a catalog and corresponding display of all approved Expert data so that all users can view same and decide which of these areas they want to have access to from within their own WS. While Expert Users create their expert data, i.e., create a top-folder, with optionally sub-folders, and populate same with entries, which contain the expert data, they also have means to flag said top-folder accordingly, so that the system recognizes their intention to have said data be shared with other users. In doing so, the Expert User provides a short description of such data, which becomes an attribute to said top-folder. Another attribute, which is added to said top-folder is designated as the “Data Source Name”. The Data Source name will default to the name of the corresponding top-folder, but the WS owner, i.e., the Expert can set it to any desired name.

After compiling a new Data Source the Expert user may “publish” it to the general population of users. The Expert user accomplishes this by setting a “Request to Publish” flag or attribute on any of their top-folders, which they deem being a Data Source. Admin users can manage the review and approval process of proposed Data Sources, as well as monitor the approved Data Sources at any time, using the following hierarchy:

```
+ Expert Data
    + Pending Data Sources (table used to maintain outstanding requests
      by Expert users)
    + Approved Data Sources
    + User Observations
```

This structure is implemented as a root-folder residing within the Admin WS so that an Admin user or a Power user can easily browse through this structure and manage its content, as well as take action, described as following. When an Expert user sets the Request to Publish flag on any of his/her top-folders, the system automatically creates a new entry in the “Pending Data Sources” table with DFs populated as follows:
IQ User—the IQ user ID of the Expert user;
Data Source Folder ID—pointing to the top-folder of the given Expert Data, which will provide all related data, such Data Source Name, and Description (assigned by the Expert user);
Request Date—the date that the Expert user has requested to publish the given Data Source;
Status—status of the “request to publish” the given Data Source—having possible values, such as “Reviewing”, “Approved” and “Rejected”;
Action date—the date when an Admin user changed the Status last;
Examined By—the User ID of the Admin user who changed the Status last;
Data Source Name—the Data Source name assigned by an Admin user if indeed said Data Source was approved;
Number of Entries—a counter reflecting the number of entries contained in a given Data
Source—an indication of the size of said data;
Number of Users—a counter showing the number of users who have signed up for the given Data Source; and
Average Score—the average score assigned by all users of a given Data Source—the score indicates their overall level of satisfaction from the given Data Source.

Admin users can view the pending requests for Data Sources, whether approved, rejected or where no action has yet been taken, as well as the content of each of each the Data Sources, and can take action by approving, rejecting, or any relevant action, such as indicating that the given Data Source is “being reviewed”. Another possible action is to “Terminate” a Data Source, which is applicable after a Data Source has been approved and published, which removes the Data Source from the general population of users, and those who already signed up for the given Data Source, will no longer be able to access it.

If approved, all users can view and selectively subscribe to each Approved data Source using a corresponding menu and buttons accessible in the tabular view of the “Approved Data Sources” top-folder. The approved Data Sources are displayed in a new root-folder, named “Approved Data Sources” populated with similar DFs, such as “Data Source Name”, “Description”, “Number of Subscribers”, “Average Score”, “Date Created”, “Average Score” (the average score assigned to the given WS considering the individual score assigned by all of its subscribed users), and a “My Score” DF. Users who subscribed to given Data Sources, will have the ability to “assign” a score to any such Data Sources via My Score. Each of the top-folders within the “Expert Data” root-folder, corresponding to a given Data Source, will “inherit” the DFs, DEF, FT and folder attributes configured by the Expert for the top-folder and sub-folders. However, general users will not be granted permissions to change said configuration or attributes. The scoring mechanism allows Admin users as well as general users to see which Data Sources and which specific entries are more popular and useful than others, thereby indicating credibility and also providing feedback for the respective Data Sources owners.

General users may also post User Observations via the TVRM when viewing a selected top-folder and or sub-folder corresponding to any Data Sources within the “Expert Data” area, as well as through a corresponding button in the tabular view tool bar. This engenders a User Observation form prompting the user to enter a description. Each such User Observation will automatically generate a notification, using email, SMS or any other desired method, to the Expert user. Users can review observations they have reported by a menu item, designated “View Observations” off the TVRM

Miscellaneous Features

In addition to all the foregoing the present system adds some individual web-functionality for convenience of use.

Each user can add a web site to the workspace simply by right-clicking on the page served by the given site, thereby engendering a pop-up menu with a menu item for “Add this site”. Similarly, users can save selected HTML web pages and/or PDF documents into the Workspace. These operations are facilitated by specific system-provided browser plug-ins.

Each user can launch any application associated with a given entry in the Workspace directly from that entry, and the system will automatically download the entry to the user's local client 13 system. Thus, in the case of documents or spreadsheets such as Word and Excel, the system automatically and transparently downloads the given object from the ASP local area network 17 (“LAN”) onto the user's client 13 laptop/PC; launches the application, and upon saving the work, automatically uploads the given document

Users can create a TDI from any other relevant area. For example, having a selected entry in “My Documents”, or in “My Notes”, or in My Email, and easily creating a “related” TDI. Conversely, any entry in the workspace can be used to create an associated outbound email.

If desired, the foregoing TDI or email creation can be automated, e.g., a “follow-up” TDI can be automatically triggered by receipt of certain email, or an email can be triggered by a given TDI.

It should now be apparent that the above-described invention provides a comprehensive internet-based virtual workspace, database structure and tools for organizing and managing diverse information objects including emails, contacts, bookmarks, tasks, documents, notes, and all other relevant information, all in a fully integrated and centralized fashion, thereby streamlining data management, data flow and user actions. The system is platform independent and accessible using commercially available browsers. Those skilled in the art will understand that various modifications and variations can be made in the present invention without departing from the spirit or scope of the invention. It is to be understood, therefore, that the invention may be practiced otherwise than as specifically set forth in the appended claims.

What is claimed:

1. A system for web-based data management, the system comprising:
a host computer communicatively coupled to multiple client computers via at least one network:
a database resident on said host computer and storing a plurality of data entries in a workspace comprising a plurality of defined folders and sub-folders, each of said plurality of data entries comprising one or more defined Data Fields (DFs), each DF within said folders and sub-folders storing a particular type of data from among a group of different types of data;
a plurality of pre-defined Data Field Type Indicators, each DF within said folders and sub-folders being tagged by a corresponding Data Field Type Indicator;
a plurality of pre-defined Folder Templates each associated with one of said defined folders and sub-folders, and each defining a plurality of attributes of said associated folder/sub-folder including display characteristics for displaying said folders/sub-folders in a tabular view;
a plurality of pre-defined Data Entry Forms (DEFs) each associated with one of said defined folders and sub-folders, each DEF defining how data is entered in said associated folder/sub-folder, including the display characteristics of DFs associated with said folder/sub-folder; and
a graphical user interface comprising a tree view for displaying said folders and sub-folders in a collapsible/expandable tree array, and a tabular view that displays entries of one or more selected folders/sub-folders in accordance with said associated Folder Template.

2. The system for web-based data management services according to claim 1, wherein said plurality of attributes defined by said Folder Templates include any one or more attributes from among a group including Column Headings, Entry Title, Search Fields, Copy Fields, and Initial Values.

3. The system for web-based data management services according to claim 1, wherein said plurality of pre-defined Data Field types include any from among a group including an encrypted data field for encrypted storage of an entry in the database in an encrypted fashion, a URL for storage of a URL entry in the database, a file attachment for storage of a file in the database, and an Email Reference for storage of a reference to an email address.

4. The system for web-based data management services according to claim 1, wherein said plurality of pre-defined Data Field types include a web search field for archival storage of search keywords in said database and to launch a web search using said keywords.

5. The system for web-based data management services according to claim 2, wherein said plurality of pre-defined Data Field types include “Single-value Reference DF” having a single value entry that references another data entry, and “Multi-value Reference DF” having one or more value entries that references multiple other data entries.

6. The system for web-based data management services according to claim 1, wherein said graphical user interface comprises a search engine for keywords and phrases searching all of the contents of folders and sub-folders in said tree view.

7. The system for web-based data management services according to claim 6, wherein said search engine identifies all data entries in the folders and sub-folders having data matching said keywords or search phrases, and all Single-value Reference DFs and Multi-value Reference DFs referencing said matching data entries.

8. The system for web-based data management services according to claim 5, wherein folders and sub-folders in said tree view may be related either by referencing a Single-value Reference DF or Multi-value Reference DF in each of said related folders/sub-folders, and wherein adding a data entry in one Reference DF automatically updates and adds a corresponding value entry in a corresponding Reference DF in a related folder/sub-folder.

9. The system for web-based data management services according to claim 1, wherein said a graphical user interface comprises a plurality of selectable columnar tabs where the selection of each columnar tab engenders a display of data entries of a corresponding folder/sub-folder using the tabular view and the Folder Template associated with said folder/sub-folder or a selected data entry displayed using the DEF associated with the folder/sub-folder that said data entry is part of.

10. The system for web-based data management services according to claim 1, wherein a different user-programmable Folder Template may be assigned to each folder and sub-folder said collapsible/expandable tree array.

11. The system for web-based data management services according to claim 2, wherein said plurality of attributes defined by said user-programmable Folder Templates include Copy Fields Next, which automatically copies predetermined DFs from a given data entry when creating a new data entry in the associated folder/sub-folder based on said data entry.

12. The system for web-based data management services according to claim 11 wherein said plurality of attributes of defined by said user-programmable Folder Templates include Copy Fields Other, which automatically copies predetermined DFs from an existing data entry when creating a new data entry in a different folder/sub-folder based on said entry.

13. The system for web-based data management services according to claim 11, wherein a user can create a sub-folder to a parent folder and the created sub-folder is automatically assigned the Folder Template and the DEF that are associated with the parent folder

14. The system for web-based data management services according to claim 1, wherein said a graphical user interface includes a folder configuration editor for defining said user-programmable Folder Templates.

15. The system for web-based data management services according to claim 1, wherein said a graphical user interface includes a Data Entry Form editor for allowing user-definition of said DEFs.

16. The system for web-based data management services according to claim 15, wherein each time that a user creates a folder/sub-folder an associated DEF and a Folder Template must also be defined.

17. The system for web-based data management services according to claim 1, wherein said graphical user interface tree view displays said folders and sub-folders in a collapsible/expandable and selectable tree array, each said folder/sub-folder can be selected to be displayed using the tabular view and an associated Folder Template, and said graphical user interface further comprises a Preview Pane for displaying contents of a selected data entry from said tabular view, all of said tree view, tabular view and Preview pane being concurrently displayed.

18. The system for web-based data management services according to claim 2, wherein said plurality of attributes of defined by said Folder Templates include a Task Folder attribute that automatically appends a workflow of defined status Data Fields to entries in the corresponding folder/subfolder, said status Data Fields further having attributes of “Closed” and “Completed” where the first denotes a task closed for any reason and the latter denotes a task closed with a status indicating that the goals of the task were accomplished.

19. The system for web-based data management services according to claim 18, wherein said user can selectively display said status Data Fields in said tabular view.

20. The system for web-based data management services according to claim 19, wherein said user can selectively set a status to be assigned to said Status Data Field of any given data entries in a Task Folder.

21. The system for web-based data management services according to claim 1, wherein a user may selectively allow access to any defined folder, sub-folder, selected data entries therein, or an entire Workspace by another guest user in accordance with a predefined set of permissions specifying permitted guest users, defined folders, sub-folders, or selected data entries therein to be shared with each said permitted guest user, and where said permissions include but are not limited to creating data entries, modifying existing data entries, and deleting data entries.

22. The system for web-based data management services according to claim 1, wherein a user may selectively request to publish any defined folder or sub-folder.

23. The system for web-based data management services according to claim 22, wherein a user may selectively issue a request to publish any defined folder or sub-folder, an administrative user may selectively grant said request and publish a defined folder or sub-folder, and all users may view published folders or sub-folders.

24. The system for web-based data management services according to claim 22, wherein other users may elect to view any published folder or sub-folder within their personal Workspace within the tree view of their folders/sub-folders, and said other users may rank said published folders or sub-folders.

25. The system for web-based data management services according to claim 1, wherein a user may selectively export one or more defined folders, sub-folders, or selected data entries within their Workspace , whereby a copy of said folders, sub-folders, or data entries are operational in another user's Workspace, said copy including the associated Folder Templates, DEFs and, optionally, the data entries included in said folders and sub-folders.

26. The system for web-based data management services according to claim 1, wherein a user may selectively specify one or more Reminders for any data entry in their Workspace.

27. The system for web-based data management services according to claim 26, wherein said Reminders can specify a Date or a Date/Time DF used by said data entry to be used as the basis for said Reminder.

28. The system for web-based data management services according to claim 1, whereby a user can create a new entry based on any existing entry in said workspace.

29. The system for web-based data management services according to claim 28, wherein said a graphical user interface includes a consolidated display of all subsequent entries in the Workspace that were created based on an existing entry.

30. The system for web-based data management services according to claim 29, wherein said consolidated display of all subsequent entries in the Workspace indicates the existing entry upon which said subsequent entries were based.

31. A method of controlling processing of data in a distributed computer system including a web-enabled computer server and a plurality of remote workstations in communication with said web-enabled computer server, comprising the steps of:
defining a workspace comprising a plurality of defined folders and sub-folders resident in a database on said host computer;
defining a plurality of Folder Templates each associated with one of said defined folders and sub-folders, and each defining a plurality of attributes of said associated folder/sub-folder including display characteristics for displaying said folders/sub-folders in a tabular view;
defining a plurality of Data Entry Forms (DEFs) each associated with one of said defined folders and sub-folders, each DEF defining how data is entered in said associated folder/sub-folder, including the display characteristics of DFs associated with said folder/sub-folder;
storing a plurality of data entries within said folders and sub-folders, each of said plurality of data entries comprising one or more defined Data Fields (DFs), each DF storing a corresponding type of data from among a group of different types of data;
tagging each DF with a corresponding Data Field Type Indicator indicating the corresponding type of data entered in each said DF; and
providing a graphical user interface comprising a tree view for displaying said folders and sub-folders in a collapsible/expandable tree array, and a tabular view that displays entries of one or more selected folders/sub-folders in accordance with said associated Folder Template.

32. The method of controlling processing of data in a distributed computer system according to claim 31, wherein said plurality of attributes defined by said Folder Templates include any one or more attributes from among a group including Column Headings, Entry Title, Search Fields, Copy Fields, and Initial Values.

33. The method of controlling processing of data in a distributed computer system according to claim 31, wherein said plurality of pre-defined Data Field types include any from among a group including an encrypted data field for encrypted storage of an entry in the database in an encrypted fashion, a URL for storage of a URL entry in the database, a file attachment for storage of a file in the database, and an Email Reference for storage of a reference to an email address.

34. The method of controlling processing of data in a distributed computer system according to claim 31, wherein said plurality of pre-defined Data Field types include a web search field for archival storage of search keywords in said database and to launch a web search using said keywords.

35. The method of controlling processing of data in a distributed computer system according to claim 32, wherein said plurality of pre-defined Data Field types include “Single-value Reference DF” having a single value entry that references another data entry, and “Multi-value Reference DF” having one or more value entries that references multiple other data entries.

36. The method of controlling processing of data in a distributed computer system according to claim 31, wherein said step of providing said graphical user interface comprises providing a search engine for keywords and phrases searching all of the contents of folders and sub-folders in said tree view.

37. The method of controlling processing of data in a distributed computer system according to claim 36, further comprising a step of using search engine to identify all data entries in the folders and sub-folders having data matching said keywords or search phrases, and all Single-value Reference DFs and Multi-value Reference DFs referencing said matching data entries.

38. The method of controlling processing of data in a distributed computer system according to claim 35, further comprising a step of relating folders and sub-folders in said tree view either by referencing a Single-value Reference DF or Multi-value Reference DF in each of said related folders/sub-folders, whereby adding a data entry in one Reference DF automatically updates and adds a corresponding value entry in a corresponding Reference DF in a related folder/sub-folder.

39. The method of controlling processing of data in a distributed computer system according to claim 31, wherein said step of providing a graphical user interface comprises providing a plurality of selectable columnar tabs where the selection of each columnar tab engenders a display of data entries of a corresponding folder/sub-folder using the tabular view and the Folder Template associated with said folder/sub-folder or a selected data entry displayed using the DEF associated with the folder/sub-folder that said data entry is part of.

40. The method of controlling processing of data in a distributed computer system according to claim 31, further comprising a step of assigning a different user-programmable Folder Template to each folder and sub-folder said collapsible/expandable tree array.

41. The method of controlling processing of data in a distributed computer system according to claim 32, wherein said plurality of attributes defined by said user-programmable Folder Templates include Copy Fields Next, which automatically copies predetermined DFs from a given data entry when creating a new data entry in the associated folder/sub-folder based on said data entry.

42. The method of controlling processing of data in a distributed computer system according to claim 41 wherein said plurality of attributes of defined by said user-programmable Folder Templates include Copy Fields Other, which automatically copies predetermined DFs from an existing data entry when creating a new data entry in a different folder/sub-folder based on said entry.

43. The method of controlling processing of data in a distributed computer system according to claim 41, further comprising a step of creating a sub-folder to a parent folder and automatically assigning the Folder Template and the DEF that associated with the parent folder to the created sub-folder.

44. The method of controlling processing of data in a distributed computer system according to claim 31, wherein said step of providing a graphical user interface includes providing a folder configuration editor for defining said user-programmable Folder Templates.

45. The method of controlling processing of data in a distributed computer system according to claim 31, wherein said step of providing a graphical user interface includes providing a Data Entry Form editor for allowing user-definition of said DEFs.

46. The method of controlling processing of data in a distributed computer system according to claim 45, further comprising a step of associated a DEF and a Folder Template to each folder/sub-folder created by a user.

47. The method of controlling processing of data in a distributed computer system according to claim 31, wherein said step of providing a graphical user interface includes displaying said folders and sub-folders in said tree view in a collapsible/expandable and selectable tree array wherein each said folder/sub-folder can be selected to be displayed using the tabular view and an associated Folder Template, and providing a Preview Pane for displaying contents of a selected data entry from said tabular view, all of said tree view, tabular view and Preview pane being concurrently displayed.

48. The method of controlling processing of data in a distributed computer system according to claim 32, wherein said plurality of attributes of defined by said Folder Templates include a Task Folder attribute that automatically appends a workflow of defined status Data Fields to entries in the corresponding folder/subfolder, said status Data Fields further having attributes of “Closed” and “Completed” where the first denotes a task closed for any reason and the latter denotes a task closed with a status indicating that the goals of the task were accomplished.

49. The method of controlling processing of data in a distributed computer system according to claim 48, further comprising a step of selectively displaying said status Data Fields in said tabular view.

50. The method of controlling processing of data in a distributed computer system according to claim 49, further comprising a step of selectively setting a status to be assigned to said Status Data Field of any given data entries in a Task Folder.

51. The method of controlling processing of data in a distributed computer system according to claim 31, further comprising a step of said user selectively providing access to any defined folder, sub-folder, selected data entries therein, or an entire workspace by another guest user in accordance with a predefined set of permissions specifying permitted guest users, defined folders, sub-folders, or selected data entries therein to be shared with each said permitted guest user, and where said permissions include but are not limited to creating data entries, modifying existing data entries, and deleting data entries.

52. The method of controlling processing of data in a distributed computer system according to claim 31, further comprising a step of said user selectively requesting to publish any defined folder or sub-folder.

53. The method of controlling processing of data in a distributed computer system according to claim 52, further comprising a step of an administrative user selectively granting said request to publish and publishing a defined folder or sub-folder, whereby all users may view published folders or sub-folders.

54. The method of controlling processing of data in a distributed computer system according to claim 52, further comprising a step of other users viewing any published folder or sub-folder within their personal Workspace within the tree view of their folders/sub-folders, and said other users ranking said published folders or sub-folders.

55. The method of controlling processing of data in a distributed computer system according to claim 31, further comprising a step of a user selectively exporting one or more defined folders, sub-folders, or selected data entries within their Workspace , whereby a copy of said folders, sub-folders, or data entries become operational in another user's Workspace, said copy including the associated Folder Templates, DEFs and, optionally, the data entries included in said folders and sub-folders.

56. The method of controlling processing of data in a distributed computer system according to claim 31, further comprising a step of a user selectively specifying one or more Reminders for any data entry in their Workspace.

57. The method of controlling processing of data in a distributed computer system according to claim 56, wherein said Reminders can specify a Date or a Date/Time DF used by said data entry to be used as the basis for said Reminder.

58. The method of controlling processing of data in a distributed computer system according to claim 31, further comprising a step of a user creating a new entry based on any existing entry in said workspace.

59. The method of controlling processing of data in a distributed computer system according to claim 58, wherein said step of providing a graphical user interface includes providing a consolidated display of all subsequent entries in the Workspace that were created based on an existing entry.

60. The method of controlling processing of data in a distributed computer system according to claim 59, wherein said consolidated display of all subsequent entries in the Workspace indicates the existing entry upon which said subsequent entries were based.

61. A computer program stored on computer readable media at web-enabled computer for instructing said web-enabled computer to implement a method of controlling the processing of data and communicating to a plurality of remote workstations in communication with said web-enabled computer server in accordance with the steps of:
storing a plurality of data entries in a database resident on said web-enabled computer within a workspace comprising a plurality of defined folders and sub-folders, each of said plurality of data entries comprising one or more defined Data Fields (DFs), each DF within said folders and sub-folders storing one of a plurality of different types of data;
assigning a defined Folder Template to each of said folders and sub-folders, each defined Folder Template defining a plurality of attributes of said associated folder/sub-folder including display characteristics for displaying said folders/sub-folders;
displaying said plurality of defined folders and sub-folders in a graphical user interface comprising a hierarchal tree view in a collapsible/expandable array;
selecting one of said defined folders or sub-folders using said graphical user interface;
displaying the plurality of data entries stored in the selected folder or sub-folders in said graphical user in a separate tabular view in accordance with the assigned Folder Template.

62. The computer program according to claim 61, wherein said step of storing said plurality of data entries comprises tagging each DF with a corresponding Data Field Type Indicator indicating the corresponding type of data entered in each said DF.

63. The computer program according to claim 61, wherein said plurality of attributes defined by said Folder Templates include any one or more attributes from among a group including Column Headings, Entry Title, Search Fields, Copy Fields, and Initial Values.

64. The computer program according to claim 62, wherein said plurality of pre-defined Data Field types include any from among a group including an encrypted data field for encrypted storage of an entry in the database in an encrypted fashion, a URL for storage of a URL entry in the database, a file attachment for storage of a file in the database, and an Email Reference for storage of a reference to an email address.

65. The computer program according to claim 62, wherein said plurality of pre-defined Data Field types include a web search field for archival storage of search keywords in said database and to launch a web search using said keywords.

66. The computer program according to claim 62, wherein said plurality of pre-defined Data Field types include “Single-value Reference DF” having a single value entry that references another data entry, and “Multi-value Reference DF” having one or more value entries that references multiple other data entries.

67. The computer program according to claim 61, wherein said graphical user interface comprises a search engine for keywords and phrases searching all of the contents of folders and sub-folders in said tree view.

68. The computer program according to claim 67, wherein said search engine identifies all data entries in the folders and sub-folders having data matching said keywords or search phrases, and all Single-value Reference DFs and Multi-value Reference DFs referencing said matching data entries.

69. The computer program according to claim 65, wherein folders and sub-folders in said tree view may be related either by referencing a Single-value Reference DF or Multi-value Reference DF in each of said related folders/sub-folders, and wherein adding a data entry in one Reference DF automatically updates and adds a corresponding value entry in a corresponding Reference DF in a related folder/sub-folder.

70. The computer program according to claim 61, wherein said a graphical user interface comprises a plurality of selectable columnar tabs where the selection of each columnar tab engenders a display of data entries of a corresponding folder/sub-folder using the tabular view and the Folder Template associated with said folder/sub-folder or a selected data entry displayed using the DEF associated with the folder/sub-folder that said data entry is part of

71. The computer program according to claim 61, wherein said plurality of attributes defined by said user-programmable Folder Templates include Copy Fields Next, which automatically copies predetermined DFs from a given data entry when creating a new data entry in the associated folder/sub-folder based on said data entry.

72. The computer program according to claim 71 wherein said plurality of attributes of defined by said user-programmable Folder Templates include Copy Fields Other, which automatically copies predetermined DFs from an existing data entry when creating a new data entry in a different folder/sub-folder based on said entry.

73. The computer program according to claim 61, wherein a user can create a sub-folder to a parent folder and the created sub-folder is automatically assigned the Folder Template and the DEF that are associated with the parent folder

74. The computer program according to claim 61, wherein said a graphical user interface includes a folder configuration editor for defining said user-programmable Folder Templates.

75. The computer program according to claim 61, wherein said a graphical user interface includes a Data Entry Form editor for allowing user-definition of said DEFs.

76. The computer program according to claim 75, wherein each time that a user creates a folder/sub-folder an associated DEF and a Folder Template must also be defined.

77. The computer program according to claim 61, wherein said graphical user interface tree view displays said folders and sub-folders in a collapsible/expandable and selectable tree array, each said folder/sub-folder can be selected to be displayed using the tabular view and an associated Folder Template, and said graphical user interface further comprises a Preview Pane for displaying contents of a selected data entry from said tabular view, all of said tree view, tabular view and Preview pane being concurrently displayed.

78. The computer program according to claim 62, wherein said plurality of attributes of defined by said Folder Templates include a Task Folder attribute that automatically appends a workflow of defined status Data Fields to entries in the corresponding folder/subfolder, said status Data Fields further having attributes of “Closed” and “Completed” where the first denotes a task closed for any reason and the latter denotes a task closed with a status indicating that the goals of the task were accomplished.

79. The computer program according to claim 78, wherein said user can selectively display said status Data Fields in said tabular view.

80. The computer program according to claim 79, wherein said user can selectively set a status to be assigned to said Status Data Field of any given data entries in a Task Folder.

81. The computer program according to claim 61, wherein a user may selectively allow access to any defined folder, sub-folder, selected data entries therein, or an entire Workspace by another guest user in accordance with a predefined set of permissions specifying permitted guest users, defined folders, sub-folders, or selected data entries therein to be shared with each said permitted guest user, and where said permissions include but are not limited to creating data entries, modifying existing data entries, and deleting data entries.

82. The computer program according to claim 61, wherein a user may selectively request to publish any defined folder or sub-folder.

83. The computer program according to claim 82, wherein a user may selectively issue a request to publish any defined folder or sub-folder, an administrative user may selectively grant said request and publish a defined folder or sub-folder, and all users may view published folders or sub-folders.

84. The computer program according to claim 82, wherein other users may elect to view any published folder or sub-folder within their personal Workspace within the tree view of their folders/sub-folders, and said other users may rank said published folders or sub-folders.

85. The computer program according to claim 81, wherein a user may selectively export one or more defined folders, sub-folders, or selected data entries within their Workspace , whereby a copy of said folders, sub-folders, or data entries are operational in another user's Workspace, said copy including the associated Folder Templates, DEFs and, optionally, the data entries included in said folders and sub-folders.

86. The computer program according to claim 61, wherein a user may selectively specify one or more Reminders for any data entry in their Workspace.

87. The computer program according to claim 86, wherein said Reminders can specify a Date or a Date/Time DF used by said data entry to be used as the basis for said Reminder.

88. The computer program according to claim 61, whereby a user can create a new entry based on any existing entry in said Workspace.

89. The computer program according to claim 88, wherein said a graphical user interface includes a consolidated display of all subsequent entries in the Workspace that were created based on an existing entry.

90. The computer program according to claim 89, wherein said consolidated display of all subsequent entries in the Workspace indicates the existing entry upon which said subsequent entries were based.
